(19) United States
(12) Patent Application Publication
(10) Pub. No.: US 2026/0032275 A1
(43) Pub. Date: Jan. 29, 2026

(54) METHOD AND APPARATUS FOR ENCAPSULATING POINT CLOUD FILE, METHOD AND APPARATUS FOR DECAPSULATING POINT CLOUD FILE, DEVICE, AND STORAGE MEDIUM

(71) Applicant: Tencent Technology (Shenzhen) Company Limited, Shenzhen (CN)

(72) Inventors: Ying Hu, Shenzhen (CN); Xiaozhong Xu, Shenzhen (CN)

(21) Appl. No.: 19/347,599

(22) Filed: Oct. 1, 2025

Related U.S. Application Data
(63) Continuation of application No. PCT/CN2024/108636, filed on Jul. 30, 2024.

(30) Foreign Application Priority Data
Aug. 21, 2023 (CN) 202311055895.4

(51) Int. Cl. H04N 19/44; H04N 19/597

(52) U.S. Cl. CPC H04N 19/44; H04N 19/597

(57) ABSTRACT

This application provides a method for decapsulating a point cloud file performed by an electronic device. The method includes: determining target first attribute data from a point cloud file, the point cloud file being generated by encapsulating a point cloud bitstream; determining dependency indication information of the first attribute data, the dependency indication information indicating whether a first relationship exists between the first attribute data and second attribute data in the point cloud file; and decoding the first attribute data based on the dependency indication information. To be specific, according to this application, encoding and decoding dependency relationships or the presentation association relationship between different point cloud attribute data is indicated with the dependency indication information, thus supporting partial access, correct decoding, and personalized presentation of a point cloud bitstream.

### CROSS-REFERENCE TO RELATED APPLICATIONS

This application is a continuation application of PCT Patent Application No. PCT/CN2024/108636, entitled “METHOD AND APPARATUS FOR ENCAPSULATING POINT CLOUD FILE, METHOD AND APPARATUS FOR DECAPSULATING POINT CLOUD FILE, DEVICE, AND STORAGE MEDIUM” filed on Jul. 30, 2024, which claims the priority to Chinese Patent Application No. 202311055895.4, entitled “METHOD AND APPARATUS FOR ENCAPSULATING POINT CLOUD FILE, METHOD AND APPARATUS FOR DECAPSULATING POINT CLOUD FILE, DEVICE, AND STORAGE MEDIUM” filed with the China National Intellectual Property Administration on Aug. 21, 2023, both of which are incorporated herein in their entirety by reference.

### FIELD OF THE TECHNOLOGY

Embodiments of this application relate to the technical field of video processing, and in particular, to a method and apparatus for encapsulating a point cloud file, a method and apparatus for decapsulating a point cloud file, a device, and a storage medium.

### BACKGROUND OF THE DISCLOSURE

Immersive media refer to media contents capable of providing consumers with immersive experience. They can be divided into three degrees of freedom (DoF) media, 3DoF+ media, and 6DoF media according to the degrees of freedom of media content consuming of users.

The immersive media include point cloud media. Existing point cloud media can partially access a point cloud bitstream by defining sub-samples or multi-track encapsulation modes. However, they cannot partially access attribute information in the point cloud bitstream.

### SUMMARY

This application provides a method and apparatus for encapsulating a point cloud file, a method and apparatus for decapsulating a point cloud file, a device, and a storage medium, through which access, correct decoding, and personalized presentation of parts of attribute data in a point cloud bitstream are implemented by indicating an association relationship between attribute data with dependency indication information.

In a first aspect, this application provides a method for encapsulating a point cloud file performed by an electronic device. The method includes:
determining target first attribute data from a point cloud file, the point cloud file being generated by encapsulating a point cloud bitstream;
determining dependency indication information of the first attribute data, the dependency indication information indicating whether a first relationship exists between the first attribute data and second attribute data in the point cloud file; and
decoding the first attribute data based on the dependency indication information.

In a second aspect, this application provides a method for encapsulating a point cloud file. The method includes:
acquiring a point cloud bitstream, the point cloud bitstream including N groups of attribute data, and N being a positive integer; and
encapsulating, for target first attribute data in the N groups of attribute data, the first attribute data based on a first relationship between the first attribute data and second attribute data, determining dependency indication information of the first attribute data, and acquiring the point cloud file; the dependency indication information being configured for indicating whether the first relationship exists between the first attribute data and the second attribute data, and the first relationship including at least one of an encoding dependency relationship and a presentation association relationship.

In a third aspect, an electronic device is provided. The electronic device includes: a processor and a memory, the memory being configured to store a computer program, and the processor being configured to invoke and run the computer program stored in the memory and causing the electronic device to perform the method in the first aspect or the second aspect.

In a fourth aspect, a chip is provided. The chip is configured to implement the method in any one aspect or implementations of the first aspect. Specifically, the chip includes: a processor configured to invoke and run a computer program from a memory and causing a device having the chip mounted therein to perform the method in the first aspect or the second aspect.

In a fifth aspect, a non-transitory computer-readable storage medium is provided. The computer-readable storage medium is configured to have a computer program stored therein, the computer program, when executed by a processor of an electronic device, causing the electronic device to perform the method in the first aspect or the second aspect.

To sum up, in this application, the to-be-decoded first attribute data is determined from the point cloud file. The dependency indication information of the first attribute data is determined, the dependency indication information is configured for indicating whether the first relationship exists between the first attribute data and the second attribute data, and the first relationship includes at least one of the decoding dependency relationship and the presentation association relationship. The first attribute data are further decoded based on the dependency indication information. To be specific, according to this application, encoding and decoding dependency relationships or the presentation association relationship between different point cloud attribute data is indicated with the dependency indication information, thus supporting partial access, the correct decoding, and the personalized presentation of the point cloud bitstream.

### BRIEF DESCRIPTION OF THE DRAWINGS

To describe technical solutions of embodiments of the present disclosure more clearly, accompanying drawings required for description of the embodiments will be briefly described below. Apparently, the accompanying drawings in the following description show merely some embodiments of the present disclosure, and a person of ordinary skill in the art can still derive other accompanying drawings from these accompanying drawings without creative efforts.

FIG. 1 exemplarily shows a schematic diagram of three degrees of freedom;

FIG. 2 exemplarily shows a schematic diagram of three degrees of freedom+;

FIG. 3 exemplarily shows a schematic diagram of six degrees of freedom;

FIG. 4A is an architecture diagram of an immersive media system according to an embodiment of this application;

FIG. 4B is a schematic diagram of a point cloud system framework according to an embodiment of this application;

FIG. 5A is a schematic structural diagram of a geometry point cloud sample stored in a single track;

FIG. 5B is a schematic structural diagram of component-based multi-track encapsulation;

FIG. 5C is a schematic structural diagram of slice-based multi-track encapsulation;

FIG. 5D is a schematic structural diagram of slice-based multi-track encapsulation;

FIG. 6 is a flowchart of a method for decapsulating a point cloud file according to an embodiment of this application;

FIG. 7A is a schematic diagram of multi-track encapsulation involved in an embodiment of this application;

FIG. 7B is a schematic diagram of single-track encapsulation involved in an embodiment of this application;

FIG. 8 is a flowchart of a method for encapsulating a point cloud file according to an embodiment of this application;

FIG. 9 is a schematic structural diagram of an apparatus for decapsulating a point cloud file according to an embodiment of this application;

FIG. 10 is a schematic structural diagram of an apparatus for encapsulating a point cloud file according to an embodiment of this application; and

FIG. 11 is a schematic block diagram of an electronic device according to an embodiment of this application;

### DESCRIPTION OF EMBODIMENTS

The technical solutions in embodiments of the present disclosure will be clearly and completely described below with reference to accompanying drawings in the embodiments of the present disclosure. Apparently, the described examples are merely some embodiments rather than all embodiments of the present disclosure. All other embodiments derived by a person skilled in the art from the embodiments of the present disclosure without creative efforts are to fall within the protection scope of the present disclosure.

The terms “first”, “second”, etc. in the description, the claims, and the accompanying drawings of the present disclosure are used to distinguish similar objects, but are not necessarily used to describe a specific sequence or a sequential order. Data used in this way are interchangeable under appropriate circumstances, such that the embodiment of the present disclosure described herein can be implemented in a sequence other than those illustrated or described herein. In addition, terms “comprise”, “include”, “provide with”, and their any variation are intended to cover non-exclusive inclusions. For example, processes, methods, systems, products, or devices that include a series of steps or units are not necessarily limited to those steps or units clearly listed, but can include other steps or units not explicitly listed or inherent to these processes, methods, products, or devices.

The embodiment of this application relates to data processing technology of immersion media.

Before the technical solution of this application is introduced, the related knowledge of this application is introduced at first as follows:

Multi-view/multi-viewpoint video: a video with depth information shot from a plurality of angles by using a plurality of camera arrays. The multi-view/multi-viewpoint video is alternatively referred to a free-view/free-viewpoint video and is immersive media that provide six-degree-of-freedom experience.

Point cloud: a group of discrete point sets that are randomly distributed and express a spatial structure and a surface attribute of a three-dimensional object or scenario in space. Each point in the point cloud has at least three-dimensional position information, and may alternatively have color, material or other information according to different application scenarios. Generally, every point in a point cloud has a same number of additional attributes.

PCC: point cloud compression.

G-PCC: geometry-based point cloud compression.

V-PCC: video-based point cloud compression.

Slice: a point cloud slice/point cloud strip representing a set of a series of syntax elements (such as a geometry slice and an attribute slice) of partially or all encoded point cloud frame data.

Sequence header: a point cloud sequence header parameter set, a parameter set required for point cloud sequence decoding. (defined by the Audio Video Coding Standard (AVS))

Geometry header: a point cloud frame geometry header parameter set, a parameter set required for point cloud geometry data decoding.

Attribute header: a point cloud frame attribute header parameter set, a parameter set required for point cloud attribute data decoding.

SPS: a sequence parameter set, a parameter set required for point cloud sequence decoding. (defined by the Moving Picture Experts Group (MPEG))

GPS: a geometry parameter set, a parameter set required for point cloud geometry data decoding.

APS: an attribute parameter set, a parameter set required for point cloud attribute data decoding.

Atlas: regional information on a two-dimensional (2D) planar frame, regional information of a three-dimensional (3D) presentation space, as well as a mapping relationship between the two pieces of regional information, and necessary parameter information required for mapping.

Track: a media data set in a process of media file encapsulation, and is composed of a plurality of timing samples. A media file may be composed of one or more tracks. For example, a media file may commonly include a video media track, an audio media track, and a subtitle media track. In particular, metadata information may alternatively be included in the file as a media type in the form of metadata media tracks.

Sample: an encapsulation unit in the encapsulation process of the media file. One track is composed of a plurality of samples, and each sample corresponds to specific timestamp information. For example, one video media track may be composed of a plurality of samples, and one sample is usually one video frame. In the embodiment of this application, one sample in the point cloud media track may be one point cloud frame.

Sample number: a serial number of a specific sample. A serial number of a first sample in the track is 1.

Sample entry: a sample entry configured to indicate the metadata information related to all samples in the track. For example, the sample entry of the video track usually includes metadata information related to decoder initialization.

Sample group: a sample group configured to group some samples in the track according to a specific rule.

Item: a data item, and the data item is a media data set in a process of static media file encapsulation. For example, a static picture is encapsulated as one item.

Slice: a point cloud slice/point cloud strip representing a set of a series of syntax elements (such as a geometry slice and an attribute slice) of partially or all encoded point cloud frame data. One slice corresponds to one point in a particular spatial region.

DASH: dynamic adaptive streaming over hypertext transfer protocol (HTTP).

The dynamic adaptive streaming over HTTP is an adaptive bitrate streaming technology enabling high-quality streaming media to be delivered via the Internet through a conventional HTTP network server.

MPD: media presentation description signaling in the DASH, and is configured to describe media segment information.

Representation: a combination of one or more media components in the DASH. For example, a video file with a particular resolution may be regarded as one presentation.

Adaptation sets: sets of one or more video streams in the DASH, and the Adaptation Sets may include a plurality of representations.

Media segment: a playable segment that conforms to a particular media format. When played, the segment may need to cooperate with previous 0 or more segments and initialized segments.

DoF: a degree of freedom. The degree of freedom refers to a number of independent coordinates in a mechanical system, and includes a translation degree of freedom, and further includes degrees of freedom of rotation and vibration. The degree of freedom refers to a degree of freedom of motion support and content interaction production when a user views the immersive media in the embodiment of this application.

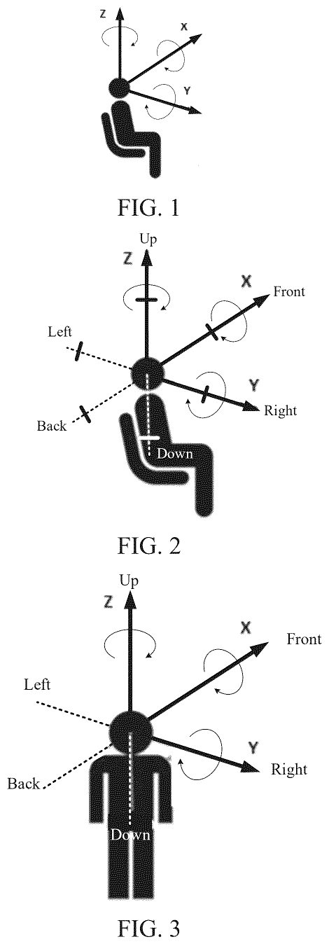

3DoF: three degrees of freedom, and particularly refers to the three degrees of freedom of rotation of a head of the user around XYZ axes. FIG. 1 exemplarily shows a schematic diagram of three degrees of freedom. As shown in FIG. 1, the three degrees of freedom refers to rotation, turning the head, raising or bowing the head, and swinging the head on three axes at a particular place and a particular point. Through three-degree-of-freedom experience, the user can be immersed in a scene 360 degrees. If the scene is static, the scene may be understood as a panoramic picture. If the panoramic picture is dynamic, the panoramic picture is a panoramic video, to be specific, a virtual reality (VR) video. However, the VR video has particular limitation, and the user cannot move or choose any place for view.

3DoF+: the user further has a degree of freedom to do limited motion along the XYZ axes based on the three degrees of freedom, and may alternatively be referred to as limited six degrees of freedom. A corresponding media bit stream may be referred to as a limited six-degree-of-freedom media bit stream. FIG. 2 exemplarily shows a schematic diagram of three degrees of freedom+.

6DoF: the user further has a degree of freedom to do free motion along the XYZ axes based on the three degrees of freedom. A corresponding media bitstream may be referred to as a six-degree-of-freedom media bit stream. FIG. 3 exemplarily shows a schematic diagram of six degrees of freedom. The 6DoF media refer to 6-DoF videos, and indicate that the video may provide the user with high-degree-of-freedom view experience of freely moving a viewpoint in directions of the XYZ axes and freely rotating the viewpoint around the XYZ axes in the three-dimensional space. The 6DoF media are video combinations at different spatial view angles collected through a camera array. To facilitate expression, storage, compression, and processing of the 6DoF media, the 6DoF media data are expressed as a combination of the following information: a texture map collected by a plurality of cameras, a depth map corresponding to the texture map of the plurality of cameras, and corresponding 6DoF media content description metadata. The metadata include parameters of the plurality of cameras, as well as description information such as stitching layout and edge protection of the 6DoF media. At an encoder side, the texture map information of the plurality of cameras and corresponding depth map information are stitched, and description data of a stitching mode are written to the metadata according to a defined syntax and semantics. The information of stitched depth map and texture map of the plurality of cameras is encoded through planar video compression, and then transmitted to a terminal for being decoded, and the 6DoF virtual viewpoint is synthesized requested by the user, thus providing the user with the view experience of the 6DoF media.

AVS: the Audio Video Coding Standard in China.

MPEG: a moving picture experts group, and is an organization established by the International Standardization Organization (ISO) and the International Electrotechnical Commission (IEC) for specifically formulating international standards for motion pictures and voice compression.

ISOBMFF: an ISO based media file format. ISOBMFF is an encapsulation standard of media files, and a most typical ISOBMFF file is a mobile pentium 4 (MP4) file.

Smart media transport (SMT): a smart media transport standard, specifies the smart media transport technology covering an encapsulation format, a transport protocol, and a signaling message, and is applied to transport and transmission of multimedia data.

Asset: a media resource, namely, any multimedia data entity related to a unique identifier and configured to establish a multimedia presentation.

The immersive media refer to media contents capable of providing consumers with immersive experience. They can be divided into DoF media, 3DoF+ media, and 6DoF media according to the degrees of freedom of media content consuming of users. Common 6DoF media include multi-view videos and point cloud media.

The point cloud refers to a group of discrete point sets that are randomly distributed and express a spatial structure and a surface attribute of a three-dimensional object or scenario in space. Each point in the point cloud has at least three-dimensional position information, and may alternatively have color, material or other information according to different application scenarios. Generally, every point in a point cloud has the same number of additional attributes.

The point cloud may flexibly and conveniently express the spatial structure and the surface attribute of the three-dimensional object or scenario, and thus is widely used. The point cloud includes a virtual reality (VR) game, computer aided design (CAD), a geography information system (GIS), an autonomous navigation system (ANS), digital cultural heritage, free viewpoint broadcasting, three-dimensional immersive remote presentation, three-dimensional reconstruction of a biological tissue and organ, etc.

The point cloud is mainly acquired by the following methods: computer generation, 3D laser scanning, 3D photogrammetry, etc. A computer may generate the point cloud of a virtual three-dimensional object and scenario. The 3D scanning may acquire a point cloud of a three-dimensional object or scenario in a static reality world, and may acquire millions of point clouds per second. The 3D photogrammetry may acquire a point cloud of a three-dimensional object or scenario in a dynamic reality world, and may acquire tens of millions of point clouds every second. In addition, in the medical field, a point cloud of the biological tissue and organ may be acquired from magnetic resonance imaging (MRI), computed tomography (CT), and electromagnetic positioning information. These technologies reduce cost and shorten a time period of point cloud data acquisition, and improve accuracy of data. The transformation of the point cloud data acquisition mode makes acquisition of mass point cloud data possible. With continuous accumulation of large-scale point cloud data, efficient storage, transmission, publishing, sharing, and standardization of the point cloud data become keys to point cloud application.

After the point cloud content is encoded, an encoded data stream needs to be encapsulated and transmitted to the user. Correspondingly, in a point cloud media player end, the point cloud file needs to be decapsulated at first, and then decoded, and finally the decoded data stream is presented. Thus, in a decapsulation link, after specific information is acquired, efficiency of a decoding link can be improved to a particular extent, and better experience is further brought to presentation of the point cloud media.

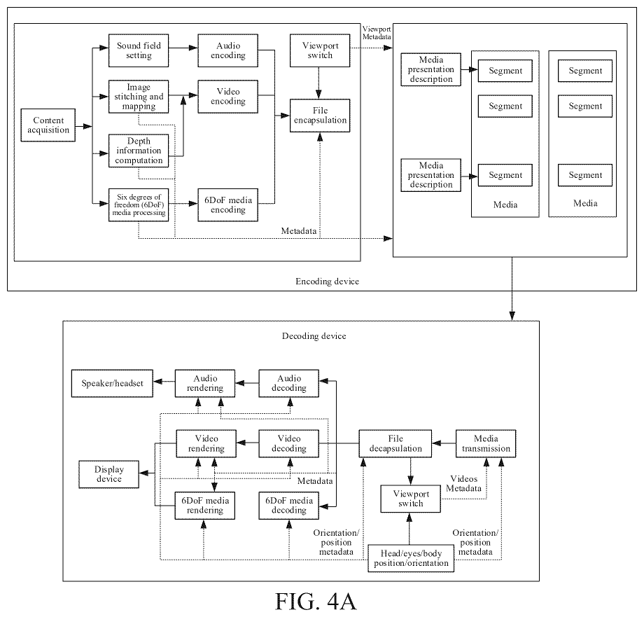

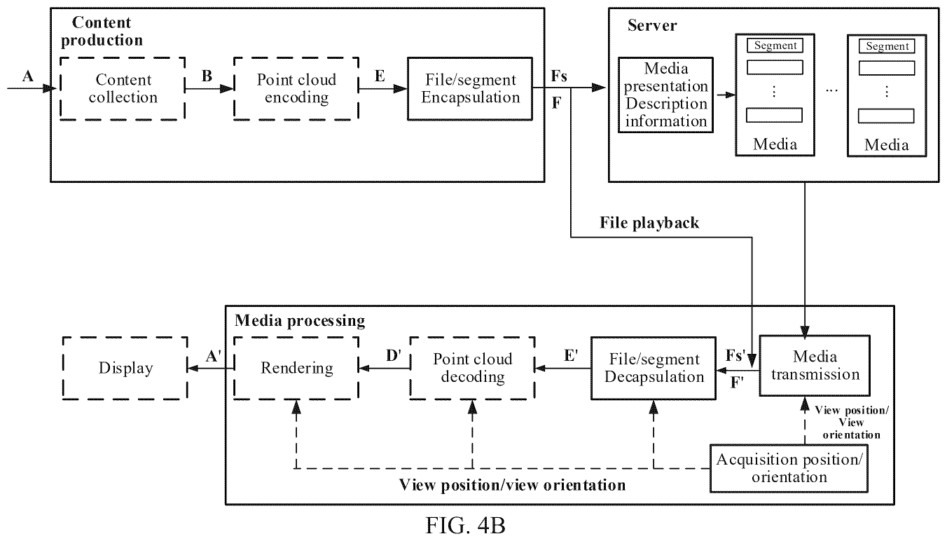

FIG. 4A is an architecture diagram of an immersive media system according to an embodiment of this application. As shown in FIG. 4A, the immersive media system includes an encoding device and a decoding device. The encoding device may refer to a computer device used by a provider of the immersive media, and the computer device may be a terminal (such as a personal computer (PC) and a smart mobile device (such as a smart phone)) or a server. The decoding device may refer to a computer device used by the user of the immersive media, and the computer device may be a terminal (such as a personal computer (PC), a smart mobile device (such as a smart phone), and a VR device (such as a VR helmet and VR glasses). Data processing of the immersive media includes data processing at an encoding device side and data processing at a decoding device side.

The data processing at the encoding device side mainly includes:
(1) acquisition and production processes of the media content of the immersive media; and
(2) encoding and file encapsulation of the immersive media. The data processing at the decoding device side mainly includes:
(3) file decapsulation and decoding of the immersive media; and
(4) rendering of the immersive media.

In addition, a transmission process of the immersive media is involved between the encoding device and the decoding device. The transmission process may be based on various transmission protocols, and the transmission protocols include, but are not limited to: a dynamic adaptive streaming over HTTP (DASH) protocol, a HTTP live streaming (HLS) protocol, a smart media transport protocol (SMTP), and a transmission control protocol (TCP).

With reference to FIG. 4A, the processes involved in the data processing of the immersive media will be introduced below in detail.

### I. The Data Processing at the Encoding Device Side:

### (1) The Acquisition and Production Processes of the Media Content of the Immersive Media.

### 1) the Acquisition Process of the Media Content of the Immersive Media.

In an implementation, a capture device may refer to a hardware component arranged in the encoding device. For example, the capture device refers to a microphone, a camera, a sensor, etc. of the terminal. In another implementation, the capture device may alternatively be a hardware apparatus connected to the encoding device, for example, a camera connected to the server.

The capture device may include, but is not limited to, an audio device, a camera device, and a sensing device. The audio device may include an audio sensor, a microphone, etc. The camera device may include an ordinary camera, a stereo camera, a light field camera, etc. The sensing device may include a laser device, a radar device, etc.

A plurality of capture devices may be provided. These capture devices are arranged in some specific positions in the reality space to simultaneously capture audio contents and video contents from different angles in the space, and the captured audio content and video content are synchronized in time and space. The media content collected by the capture device is referred to as original data of the immersive media.

### 2) the Production Process of the Media Content of the Immersive Media.

The captured audio content is the content suitable for audio encoding for the immersive media. The captured video content may merely become the content suitable for video encoding for the immersive media after a series of production processes. The production processes include:

\textcircled{1} Stitching. Since the captured video content is shot by the capture device at different angles, stitching refers to stitching the video contents shot at these angles into a complete video that may reflect 360-degree visual panorama of the reality space. To be specific, the stitched video is a panoramic video (or a spherical video) represented in a three-dimensional space.

\textcircled{2} Projection. The projection refers to a process of mapping a stitched 3D video to a 2-dimension (2D) image, and the 2D image projected is referred to as a projected image. A projection mode may include, but is not limited to: longitude and latitude map projection and regular hexahedron projection.

\textcircled{3} Regional encapsulation. The projected image may be encoded directly, or may be encoded after being regional encapsulation. In practice, in the process of data processing of the immersive media, video encoding efficiency of the immersive media can be greatly improved by encoding the two-dimensional projected image after regionally encapsulating the two-dimensional projected image, such that the regional encapsulation technology is widely applied to the video processing of the immersive media. The referred regional encapsulation refers to a process of converting the projected image per region. The regional encapsulation process converts the projected image into an encapsulated image. The regional encapsulation process specifically includes: the projected image is divided into a plurality of mapping regions, then the plurality of mapping regions are converted to acquire a plurality of encapsulation regions, and the plurality of encapsulation regions are mapped into the 2D image to acquire the encapsulated image. The mapping regions refer to the regions divided in the projected image before the regional encapsulation. The encapsulation regions refer to the regions in the encapsulated image after the regional encapsulation.

The conversion may include, but is not limited to, mirroring, rotating, rearranging, upsampling, downsampling, changing the resolution of region, and motion.

Since the panoramic video may be captured by the capture device, and after such a video is processed by the encoding device and transmitted to the decoding device for corresponding data processing, the user on the decoding device side can merely view 360-degree video information by performing some specific actions (such as head rotation), but cannot acquire a corresponding video change by performing a non-specific action (such as head motion), such that VR experience is poor. In view of that, additional depth information matching the panoramic video needs to be provided for enabling the user to acquire better immersion and better VR experience, and the six degrees of freedom (6DoF) production technology is involved. A case that the user can move freely in a simulated scenario is referred to as the 6DoF. When the 6DoF production technology is adopted to produce the video content of the immersive media, a light field camera, a laser device, a radar device, etc. are generally selected as the capture device to capture the point cloud data or light field data in the space. Some special processing is further required by performing the production processes \textcircled{1}-\textcircled{3}, such as point cloud data splitting and mapping, and depth information computation.

### (2) Encoding and File Encapsulation of the Immersive Media.

The captured audio content may be directly audio encoded to form an audio bit stream of the immersive media. After the production processes \textcircled{1}-\textcircled{2} or \textcircled{1}-\textcircled{3}, video encoding is performed on the projected image or the encapsulated image to acquire a video bit stream of the immersed media. For example, a packaged picture (D) is encoded into an encoded image (Ei) or an encoded video bitstream (Ev), and a captured audio (Ba) is encoded into an audio bitstream (Ea). Then, according to a specific media container file format, the encoded image, video and/or audio are combined into a media file (F) for file playback or a file sequence (Fs) of initialized segments and media segments for streaming transmission. The encoding device further includes metadata, such as projection and regional information, into the file or segment, thus presenting the decoded packaged picture advantageously.

In addition, if the 6DoF production technology is adopted, a specific encoding mode (such as point cloud encoding) needs to be adopted during video encoding. The audio bit stream and the video bit stream are encapsulated in a file container according to a file format (such as the ISO base media file format (ISOBMFF)) of the immersive media to form a media file resource of the immersive media. The media file resource may be a media file or a media file having media segments formed into the immersive media. According to a requirement for the file format of the immersive media, the metadata of the media file resource of the immersive media are recorded by using media presentation description (MPD). The metadata are a general term for information related to presentation of the immersive media, and the metadata may include description information of the media content, description information of a viewport, signaling information related to the presentation of the media content, etc. As shown in FIG. 4A, the encoding device may store the media presentation description, and the media file resource formed after data processing.

The immersive media system supports a box. The box refers to a data block or object that includes the metadata. To be specific, the box includes metadata of a corresponding media content. The immersive media may include a plurality of boxes, for example, a sphere region zooming box including metadata for describing sphere region zooming information, a 2D region zooming box including metadata for describing 2D region zooming information, and a region wise packing box including metadata for describing corresponding information during regional encapsulation.

### II. The Data Processing at the Decoding Device Side:

### (3) File Decapsulation and Decoding of the Immersive Media.

The decoding device may adaptively and dynamically acquire the media file resources of the immersive media and the corresponding media presentation description from the encoding device through recommendation by the encoding device or according to demand of the user at the decoding device side. For example, the decoding device may determine an orientation and a position of the user according to head/eyes/body movement information of the user, and then dynamically request the corresponding media file resource from the encoding device based on the determined orientation and position. The media file resources and the media presentation description are transmitted from the encoding device to the decoding device through a transmission mechanism (such as DASH and SMT). The file decapsulation at the decoding device side is opposite the file encapsulation at the encoding device side. The decoding device decapsulates the media file resource according to the file format requirement of the immersed media, so as to acquire the audio bit stream and the video bit stream. The decoding of the decoding device is opposite the encoding of the encoding device, and the decoding device decodes the audio bit stream to restore the audio content.

In addition, the decoding of the video bit stream by the decoding device includes processes as below.

\textcircled{1} The video bit stream is decoded to acquire a planar image. According to the metadata provided by the media presentation description, if the metadata indicate that the immersive media has performed the regional encapsulation, the planar image refers to the encapsulated image. If the metadata indicate that the immersive media have never performed the regional encapsulation, the planar image refers to the projected image.

\textcircled{2} If the metadata indicate that the immersive media have performed the regional encapsulation, the decoding device performs regional decapsulation on the encapsulated image to acquire the projected image. Herein, the regional decapsulation is opposite the regional encapsulation. The regional decapsulation refers to inverse conversion on the encapsulated image per region, and the regional decapsulation converts the encapsulated image into the projected image. The regional decapsulation specifically includes: according to indication of the metadata, inverse conversion is performed on a plurality of encapsulation regions in the encapsulated image, so as to acquire a plurality of to-be-mapped regions, and the to-be-mapped regions are mapped to a 2D image to acquire the projected image. The inverse conversion is opposite conversion. For example, the conversion refers to 90-degree counterclockwise rotation, and then inverse conversion refers to 90-degree clockwise rotation.

\textcircled{3} The projected image is reconstructed according to the media presentation description to be converted into the 3D image. The reconstruction herein refers to re-projecting the two-dimensional projected image into a 3D space.

### (4) the Rendering of the Immersive Media.

The decoding device renders the audio content acquired through audio decoding and the 3D image acquired through video decoding according to the metadata related to rendering and viewport in the media presentation description, and the 3D image is played and outputted after the rendering is completed. Especially, if the 3DoF and 3DoF+ production technologies are used, the decoding device renders the 3D image mainly based on a current viewpoint, parallax, depth information, etc. If the 6DoF production technology is used, the decoding device renders the 3D image in the viewport mainly based on the current viewpoint. The viewpoint refers to a view position point of the user, the parallax refers to a sight line difference between two eyes of the user or a sight line difference caused by movement, and the viewport refers to a view region.

The immersive media system supports a box. The box refers to a data block or object that includes the metadata. To be specific, the box includes metadata of a corresponding media content. The immersive media may include a plurality of boxes, for example, a sphere region zooming box including metadata for describing sphere region zooming information, a 2D region zooming box including metadata for describing 2D region zooming information, and a region wise packing box including metadata for describing corresponding information during regional encapsulation.

FIG. 4B is a schematic diagram of a point cloud system framework according to an embodiment of this application. As shown in FIG. 4B, the point cloud system includes a file encapsulation device and a file decapsulation device. In some embodiments, the file encapsulation device may be understood as the encoding device, and the file decapsulation device may be understood as the decoding device.

A visual scenario A of the reality world is captured by a camera or a camera device provided with a plurality of lenses and a sensor. A collection result is point cloud source data B, and the point cloud source data B are a frame sequence composed of a large number of point cloud frames. One or more point cloud frames are encoded into encoded point cloud bitstreams E including an encoded geometry bitstream and attribute bitstream. Encapsulation is performed according to a specific media container file format (such as the ISOBMFF), so as to acquire one or more encoded bitstreams that are combined into a file sequence (Fs) of initialized segments and media segments for streaming transmission or a media file (F) for file playback. In addition, the file encapsulation further includes the metadata into the file F or the media segment Fs, and the transmission mechanism is used to transmit the segment Fs to the player.

The file decapsulation processes a received file F′ or segment Fs′, extracts the encoded bitstream E′ and parses the metadata, and then decodes the metadata to generate point cloud data D′. During media processing, the point cloud data are rendered and displayed on a screen of a head-mounted display or any other display device according to a current view position and view direction, or a viewport determined by various types of sensors (such as a head, position, or eye movement sensor). The point cloud data are partially accessed and decoded based on the current view position or view direction and may be used to optimize the media processing. During viewport-based transmission, the current view position and view direction are also passed to a strategy module for determining a to-be received track.

The process is applicable to a real-time and on-demand use example.

The parameters in FIG. 4B are defined as follows: E/E′: an encoded G-PCC bitstream; F/F′: a media file including a track format specification, and probably including a constraint on a basic stream included in a track sample.

When the point cloud bit stream is encapsulated, three encapsulation modes exist as follows: single-track encapsulation, component-based multi-track encapsulation, and slice-based multi-track encapsulation.

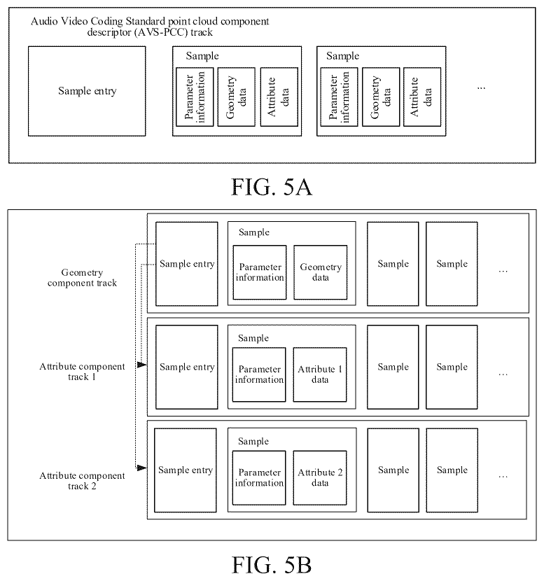

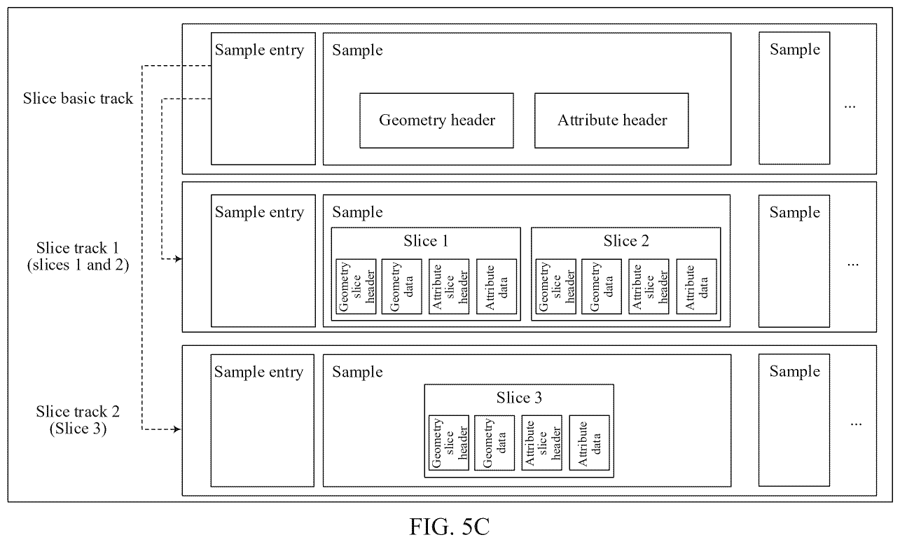

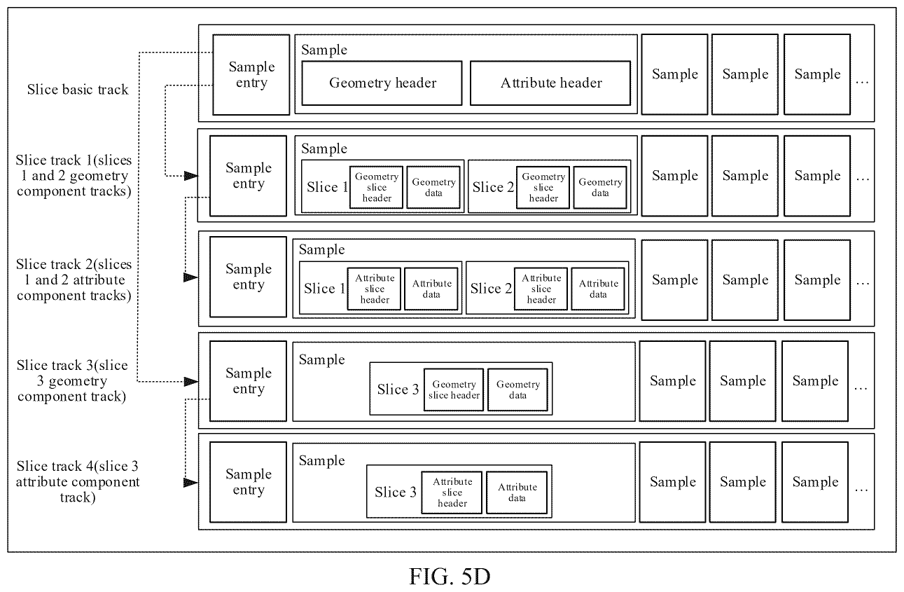

FIG. 5A is a schematic structural diagram of a geometry point cloud sample stored in a single track. As shown in FIG. 5A, attribute data and geometry data of an entire point cloud bitstream are encapsulated in one track, and the track includes one or more samples.

FIG. 5B is a schematic structural diagram of component-based multi-track encapsulation. As shown in FIG. 5B, the geometry data of the point cloud bitstream are encapsulated in several component tracks, attribute 1 data of the point cloud bitstream are encapsulated in an attribute component track 1, and attribute 2 data of the point cloud bitstream are encapsulated in an attribute component track 2. Each component track includes a plurality of samples.

FIG. 5C is a schematic structural diagram of slice-based multi-track encapsulation. As shown in FIG. 5C, point cloud-based encapsulation includes a slice basic track and one or more slice tracks. For example, point cloud bitstreams corresponding to a slice 1 and a slice 2 are encapsulated in a slice track 1, and a point cloud bitstream corresponding to a point cloud 3 is packaged in a slice track 2.

FIG. 5D is a schematic structural diagram of slice-based multi-track encapsulation. When the slice of one slice track includes some component data, a sample structure example of the slice track is shown in FIG. 5D, and includes a slice basic track, geometry component tracks of the point cloud 1 and the point cloud 2, attribute component tracks of the point cloud 1 and the point cloud 2, a geometry component track of the slice 3, and an attribute component track of the slice 3.

Each point cloud sample may be divided into one or more point cloud sub-samples. A SubSampleInformationBox is used during point cloud data encapsulation, and the sub-sample is defined according to values of flags of sub-sample information data. The flags specify a type of sub-sample information in this box as follows:

0: the sub-sample based on the type of the point cloud data. One sub-sample includes merely one data type defined by AVSPCCPayloadType.

1: a slice-based sub-sample. One sub-sample includes merely relevant information of one slice. When a corresponding track includes the component information box, the sub-sample of the corresponding track includes merely the component data corresponding to the corresponding component information box. When the corresponding track does not include the component information box, the sub-sample of the corresponding track includes all component data.

Other flag values are reserved.

A field codec_specific_parameters of SubsampleInformationBox is defined as follows:

| if(flags == 0){ | |
|---|---|
| unsined int(4) AVSPCCPayloadType; | |
| if(payloadType==2){ | |
| unsigned int(4) attr_type; | |
| bit(24) | reserved = 0; |
| } | |
| else | |
| bit(28) | reserved = 0; |
| } | |
| else if (flags == 1){ | |
| unsigned int(1) slice_data; | |
| if(slice_data) | |
| unsigned int(24) | slice_id; |
| bit(7) | reserved = 0; |
| else | |
| bit(31) | reserved = 0; |

}

AVSPCCPayloadType indicates types of the point cloud data included in the sub-sample, and the value definition is shown in the following table 1:

TABLE 1
Types of the point cloud data

| payloadType value | Description |
|---|---|
| 0 | Sequence header |
| 1 | Geometry header |
| 2 | Geometry data of the slice |
| 3 | Attribute header |
| 4 | Attribute data of the slice |
| 5 . . . 31 | Reserved |

The attr_type indicates the type of attribute data included in the sub-sample. A value of 0 indicates a color attribute. A value of 1 indicates a reflectivity attribute.

The slice_data indicates whether the sub-sample includes the data of the slice. A value of 1 indicates inclusion of the geometry and/or attribute type data of the slice. A value of 0 indicates inclusion of parameter information of the point cloud.

The slice id indicates an identifier of the slice corresponding to the data included in the sub-sample.

As may be seen from the contents above, some data units of the point cloud frame are accessed by defining the sub-sample, or the data of a specific type of or specific point cloud are accessed in a multi-track encapsulation mode. However, when the point cloud bitstream includes a plurality of a same type of attribute data, or an encoding, decoding or presentation association relationship exists between the attribute data, the related art may not accurately indicate the association relationship between these attribute data, and then may not correctly decode and personalize the presentation of some attribute data.

To solve the technical problem, the embodiments of this application provides a method for encapsulating a point cloud file and a method for decapsulating a point cloud file. For a point cloud bitstream, attribute data that have an encoding, decoding or presentation association relationship are encapsulated in a same track or a same attribute group, and encoding and decoding dependency relationships or the presentation association relationship between different point cloud attribute data is indicated with dependency indication information, thus supporting partial access, correct decoding, and personalized presentation of the point cloud bitstream.

The technical solutions of the embodiments of this application are described below in detail with reference to some embodiments. The several specific embodiments below can be combined with one another, and the same or similar concepts or processes will not be repeated in some embodiments probably.

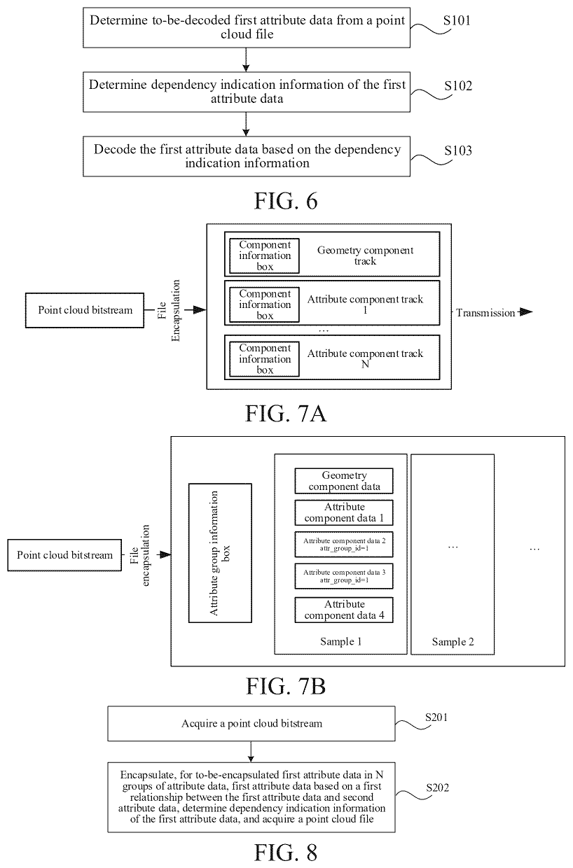

FIG. 6 is a flowchart of a method for decapsulating a point cloud file according to an embodiment of this application. The embodiment of this application may be completed by the file decapsulation device or the decoder, and the description will be provided below with the file decapsulation device being a performing body as an example.

As shown in FIG. 6, the method includes the following operations:

S101: Determine to-be-decoded first attribute data from the point cloud file.

The point cloud file is a file acquired by encapsulating a point cloud bitstream.

In the embodiment of this application, point cloud data are encoded to acquire the point cloud bitstream. In some embodiments, the point cloud bitstream is also referred to as a point cloud bit stream. The point cloud includes geometry information and attribute information. The geometry information is encoded to acquire a geometry bit stream (or referred to as the geometry bitstream), and the attribute information is encoded to acquire an attribute bit stream (or referred to as attribute bitstream). The point cloud bitstream of the embodiment of this application includes at least the attribute bitstream. For example, the point cloud bitstream of the embodiment of this application includes the geometry bitstream and the attribute bitstream, or the point cloud bitstream of the embodiment of this application includes merely the attribute bitstream.

In some embodiments, the point cloud bitstream of the embodiment of this application includes geometry data and N groups of attribute data, and N is a positive integer, The N groups of attribute data may alternatively be understood as N attribute components. For example, each point in the point cloud includes N attribute data, such that the entire point cloud includes N groups of attribute data or N attribute components, and one group of attribute data or one attribute component includes attribute data of all points in the point cloud. The geometry data may be understood as the geometry bitstreams, and the attribute data may be understood as the attribute bitstreams.

In the embodiment of this application, the point cloud encapsulation device (such as the server) encapsulates the point cloud bitstream after acquiring the point cloud bitstream, so as to acquire the point cloud file.

As may be seen from the contents above, the point cloud encapsulation device encapsulates the point cloud bitstream in a mode including at least single-track encapsulation, component-based multi-track encapsulation, and slice-based multi-track encapsulation.

In some embodiments, if the point cloud encapsulation device adopts the single-track encapsulation, the point cloud attribute data may be encapsulated. To be specific, point cloud attribute data that have a first relationship are divided into a same attribute group. In this way, when decoding, a decoding end may decode merely the attribute data in the same attribute group, so as to partially access and correctly decode the point cloud attribute data, and further implement personalized presentation of the point cloud attribute data.

In some embodiments, if the point cloud encapsulation device adopts the component-based multi-track encapsulation, the point cloud attribute data that have the first relationship in the point cloud bitstream may be encapsulated in a same component track. In this way, when decoding, the decoding end may decode merely the attribute data in the same component track, so as to partially access and correctly decode the point cloud attribute data, and further implement personalized presentation of the point cloud attribute data. For example, the point cloud bitstream includes the geometry data and the N groups of attribute data. The point cloud encapsulation device may encapsulate the geometry data in a separate component track, encapsulate M groups of attribute data that have a first relationship therebetween among the N groups of attribute data in a same attribute component track, and encapsulate 1 group of attribute data that does not have the first relationship with other attribute data among the N groups of attribute data in a separate attribute component track.

In some embodiments, if the point cloud encapsulation device adopts the slice-based multi-track encapsulation, the geometry data and the attribute data corresponding to a specific slice may be encapsulated in a same slice track. The point cloud attribute data that have the first relationship in the point cloud bitstream may alternatively be encapsulated in a same slice track. In this way, when decoding, the decoding end may decode merely the attribute data in the same slice track, so as to partially access and correctly decode the point cloud attribute data, and further implement personalized presentation of the point cloud attribute data. For example, the geometry data and the attribute data corresponding to the specific slice are located in a plurality of different slice tracks. For example, the geometry data are encapsulated in a separate slice track, M groups of attribute data that have the first relationship therebetween among the N groups of attribute data are encapsulated in one slice track, and 1 group of attribute data that does not have the first relationship with other attribute data among the N groups of attribute data are encapsulated in a separate slice track.

The embodiment of this application does not limit a specific type of the first relationship. For example, the first relationship may be any association relationship. In some embodiments, the first relationship includes at least one of decoding a dependency relationship and the presentation association relationship.

Further, the file encapsulation device adds corresponding metadata information according to an adopted specific encapsulation mode, so as to indicate necessary information required for decoding the file track. The necessary information indicates, for example, the first relationship between attribute data of different point clouds, for example, the encoding and decoding dependency relationships, and the presentation association relationship, and indicates the attribute information included in the file track, to be specific, a number of attribute types and a number of attributes.

Next, the file encapsulation device directly transmits the point cloud file F to a client according to a transmission mode between the file encapsulation device (such as the server) and the file decapsulation device (such as the client). Alternatively, the point cloud file F is sliced to acquire an Fs set, and file track data required by the user in a corresponding slice are transmitted to the user according to demand from the user.

The file decapsulation device decapsulates, decodes, and presents the received file.

In the embodiment of this application, the file decapsulation device determines the to-be-decoded first attribute data from the point cloud file in at least the following modes:

Mode 1: The file decapsulation device receives a complete point cloud file F, and determines to-be-decoded first attribute data based on related metadata and indication information of the point cloud file.

Mode 2: The file decapsulation device receives a file slice Fs, and determines the to-be-decoded first attribute data based on related metadata and indication information of the received file slice.

Mode 3: The file decapsulation device acquires point cloud component description information of the point cloud file. The point cloud component description information is configured for describing at least one of types of point cloud components, a type list of attribute components, a number list of attribute components of different types, an identifier of an attribute group to which the attribute component belongs, and description information of the attribute group that are included in tracks of the point cloud file. The file decapsulation device determines the to-be-decoded first attribute data from the point cloud file based on the point cloud component description information.

In mode 3, the point cloud component description information is also referred to as a point cloud component descriptor (AVS PCC component descriptor), and may identify a type of the point cloud component in the component adaptation set. The point cloud component descriptor is an EssentialProperty element, and @solutionIdUri attribute is set as “urn:avs:pccs:2022:component”.

At an adaptation set level, each point cloud component in the representation of the component adaptation set is to be represented by one point cloud component descriptor.

Exemplarily, the point cloud component descriptor is to include elements and attributes defined in Table 2.

TABLE 2
Point cloud component descriptor attributes

| Element and attribute | Use | Data type | Description |
|---|---|---|---|
| component | 0 . . . 1 | avspcc:avspccComponentType | An element whose |
| | | | attribute specifies |
| | | | information about one of |
| | | | the AVS point cloud |
| | | | components in the |
| | | | representation of the |
| | | | adaptation set. |
| component@type | M | xs:string | Indicate the type of the |
| | | | point cloud component. |
| | | | The value ‘geom’ |
| | | | indicates the geometry |
| | | | component, and the |
| | | | value ‘attr’ indicates the |
| | | | attribute component. |
| component@attr_type | CM | xs:uIntVectorType | Indicate a type list of |
| | | | attribute components, |
| | | | with different types of |
| | | | values separated by a |
| | | | blank space. Merely |
| | | | permit values between 0 |
| | | | and 255 (0 and 255 are |
| | | | inclusive). |
| | | | Merely exist only if the |
| | | | component is the point |
| | | | cloud attribute data (that |
| | | | is, the value of |
| | | | @component_type is |
| | | | “attr”). A value of 0 |
| | | | indicates inclusion of the |
| | | | color attribute, and a |
| | | | value of 1 indicates |
| | | | inclusion of the |
| | | | reflectivity attribute. |
| component@attr_num | CM | xs:uIntVectorType | Indicate a number list |
| | | | of a corresponding type |
| | | | of attribute |
| | | | components, separated |
| | | | by a blank space. |
| | | | Merely permit values |
| | | | between 0 and 255 (0 |
| | | | and 255 are inclusive). |
| | | | A number of values in |
| | | | this list is to correspond |
| | | | to the number of values |
| | | | in the |
| | | | component@attr_type |
| | | | list. |
| | | | Merely exist only if the |
| | | | component is the point |
| | | | cloud attribute data |
| | | | (that is, the value of |
| | | | @component_type is |
| | | | “attr”). |
| component@attr_group_id | O | xs:uInt | Indicate an identifier of |
| | | | the attribute group to |
| | | | which the point cloud |
| | | | attribute component |
| | | | belongs. Different |
| | | | attribute data |
| | | | belonging to a same |
| | | | attribute group have |
| | | | encoding and decoding |
| | | | dependency |
| | | | relationships or a |
| | | | presentation association |
| | | | relationship. |
| component@attr_group_label | O | xs:string | Indicate description of |
| | | | the attribute group to |
| | | | which the point cloud |
| | | | attribute component |
| | | | belongs. |

As may be seen from Table 2 above, in this embodiment of this application, the DASH signaling extension specifically indicates that the point cloud component descriptor is extended. When the type of the point cloud component is the attribute component, the number list of different types of attribute components, the identifier of the attribute group to which the attribute component belongs, and the description information of the attribute group are added. To be specific, in the embodiment of this application, if the value of component@type is ‘attr’, the point cloud component descriptor includes component@attr_type configured to indicate the type list of the attribute components, and further includes at least one of component@attr_num indicating the number list of the attribute components of a corresponding type, component@attr_group_id indicating the identifier of the attribute group to which the point cloud attribute component belongs, and component@attr_group_label indicating the description information of the attribute group to which the point cloud attribute component belongs.

Based on this, the file decapsulation device determines the to-be-decoded first attribute data from the point cloud based on the received point cloud component description information (namely, the point cloud component descriptor). For example, based on the point cloud component description information, the types of components included in the tracks in the point cloud file are determined. If the component included in the track is the attribute component, the to-be-decoded first attribute data are continuously determined according to the type list of attribute components included in the track, the number list of different types of attribute components, as well as the identifier of the attribute group to which the attribute component belongs, and the description information of the attribute group.

In some embodiments, if the point cloud data include N groups of attribute data, the first attribute data may include at least one group of attribute data in the N groups of attribute data, or parts of attribute data in one group of attribute data.

Based on the operations described above, the point cloud decapsulation device performs operation S102 after determining the to-be-decoded first attribute data from the point cloud file as below.

S102: Determine dependency indication information of the first attribute data.

The dependency indication information being configured for indicating whether the first relationship exists between the first attribute data and the second attribute data, and the first relationship including at least one of an encoding dependency relationship and a presentation association relationship.

As may be seen from the content above, in the embodiment of this application, some attribute data in the point cloud data depend on other attribute data when encoded, decoded or presented. Based on this, before decoding the first attribute data, the file decapsulation device needs to determine whether the first attribute data has the first relationship with other attribute data at first. If it is determined that the first relationship exists between the first attribute data and other attribute data, for example, the decoding dependency relationship exists between the first attribute data and the second attribute data, the second attribute data further need to be decapsulated from the point cloud file, and then the first attribute data are decoded based on the second attribute data. Thus, the correct decoding and the personalized presentation of the first attribute data are implemented, an amount of data decapsulation and decoding is reduced, and decoding efficiency of the point cloud is improved.

Thus, after determining the to-be-decoded first attribute data from the point cloud file, the file decapsulation device further needs to determine the dependency indication information of the first attribute data. The dependency indication information is configured for indicating whether the first relationship exists between the first attribute data and the second attribute data.

The embodiment of this application does not limit a specific method of determining the dependency indication information of the first attribute data.

In some embodiments, if the point cloud bitstream adopts the component-based multi-track encapsulation, the dependency indication information includes at least one of first information and second information, and S102 includes the following operations S102-A1 to S102-A2:

S102-A1: Determine a first track where the first attribute data are located.

S102-A2: Determine at least one of first information and second information that correspond to the first track, the first information being configured for indicating a number of attribute components included in the first track, and the second information being configured for indicating whether the first track includes an attribute group.

As may be seen from the content above, during the component-based multi-track encapsulation, the file encapsulation device encapsulates the attribute data that have the first relationship in one track. Based on this, in this embodiment, if the point cloud bitstream adopts the multi-track encapsulation, the track where the first attribute data are located is determined at first. For the convenience of description, the track where the first attribute data are located is recorded as the first track. For example, if the point cloud bitstream adopts the component-based multi-track encapsulation, it is determined that the component track where the first attribute data are located is the first track. For example, if the point cloud bitstream adopts the slice-based multi-track encapsulation, it is determined that the slice track where the first attribute data are located is the first track.

Next, at least one of the first information and the second information that correspond to the first track is determined.

In the embodiment of this application, the at least one of the first information and the second information that correspond to the first track is included in the point cloud file. The at least one of the first information and the second information that correspond to the first track may be acquired by parsing the point cloud file.

In this way, the file decapsulation device may determine whether the first relationship exists between the first attribute data and the second attribute data based on at least one of the first information and the second information that correspond to the first track.

For example, if the first information indicates that the number of the attribute components included in the first track is greater than 1, the decoding dependency relationship exists between the first attribute data and the second attribute data.

If the first information indicates that the number of the attribute components included in the first track is equal to 1, the decoding dependency relationship does not exist between the first attribute data and the second attribute data.

If the second information indicates that the first track includes the attribute group, the presentation association relationship exists between the first attribute data and the second attribute data.

If the second information indicates that the first track does not include the attribute group, the presentation association relationship does not exist between the first attribute data and the second attribute data.

As may be seen from the content above, based on the at least one of the first information and the second information, a case that the first relationship between the first attribute data and the second attribute data are determined specifically includes the following:

Example 1: If the dependency indication information of the first attribute data includes merely the first information and does not include the second information, the file decapsulation device may determine whether the decoding dependency relationship exists between the first attribute data and the second attribute data based on the first information. For example, if the first information indicates that the number of the attribute components included in the first track is greater than 1, the decoding dependency relationship exists between the first attribute data and the second attribute data. If the first information indicates that the number of the attribute components included in the first track is equal to 1, the decoding dependency relationship does not exist between the first attribute data and the second attribute data.

Example 2: If the dependency indication information of the first attribute data includes merely the second information and does not include the first information, the file decapsulation device may determine whether the presentation association relationship exists between the first attribute data and the second attribute data based on the second information. For example, if the second information indicates that the first track includes the attribute group, the presentation association relationship exists between the first attribute data and the second attribute data. If the second information indicates that the first track does not include the attribute group, the presentation association relationship does not exist between the first attribute data and the second attribute data.

Example 3: If the dependency indication information of the first attribute data includes the first information and the second information, the file decapsulation device may determine whether the decoding dependency relationship exists between the first attribute data and the second attribute data based on the first information, and determine whether the presentation association relationship exists between the first attribute data and the second attribute data based on the second information. For example, if the first information indicates that the number of the attribute components included in the first track is greater than 1, and the second information indicates that the first track includes the attribute group, the decoding dependency relationship and the presentation association relationship exist between the first attribute data and the second attribute data. If the first information indicates that the number of the attribute components included in the first track is greater than 1, and the second information indicates that the first track does not include the attribute group, the decoding dependency relationship exists between the first attribute data and the second attribute data but the presentation association relationship does not exist between the first attribute data and the second attribute data.

To be specific, in this embodiment, when the file decapsulation device decodes the first attribute data, if it is determined that the point cloud bitstream adopts the component-based multi-track encapsulation, the first track where the first attribute data are located is determined, the at least one of the first information and the second information that correspond to the first track is determined, and then whether the first relationship exists between the first attribute data and the second attribute data is determined based on the at least one of the first information and the second information. For example, if the first information indicates that the number of the attribute components included in the first track is greater than 1, it is determined that the decoding dependency relationship exists between the first attribute data and the second attribute data in the first track. If the first information indicates that the number of the attribute components included in the first track is equal to 1, it is determined that the decoding dependency relationship does not between the first attribute data and the second attribute data.

The embodiment of this application does not limit specific expression forms of the first information and the second information.

In some embodiments, the first information includes first attribute component number indication information attr_num configured for indicating a number of the attribute components included in the first track.

In some embodiments, the first information includes attribute component type number indication information, second attribute component type indication information attr_type_num, and second attribute component number indication information attr_num. The attribute component type number indication information attr_type_num is configured for indicating a number of different types of the attribute components included in the first track, and the second attribute component number indication information attr_num is configured for indicating a number of attribute components of each type.

In some embodiments, the second information includes an attribute group information flag, the attribute group information flag indicating whether to indicate attribute group information.

The embodiment of this application does not limit specific positions of the first information and the second information in the point cloud file.

In some embodiments, the at least one of the first information and the second information is located in the first track.

In some embodiments, the first track includes a component information box, and the at least one of the first information and the second information may be included in the component information box. To be specific, when the first attribute data are decoded, the first track where the first attribute data are located is determined, the at least one of the first information and the second information that correspond to the first track is determined from the component information box of the first track, and whether the first relationship exists between the first attribute data and the second attribute data is further determined.

In the embodiment of this application, the component information box is extended to support implementation operations of this application with details as below.

Extension of the component information box
Type of the box: ‘acif’
Included in: sample entry
Compulsory: No
Number: 0 or 1

The component information box indicates the data type of the point cloud component, namely, geometry, attributes, etc. When the box is included in the sample entry of the track, the box indicates the type of the point cloud component carried in a corresponding track. The box also provides information related to the attribute data in the attribute component track. However, when the point cloud bitstream is stored in a single-track mode, a sample entry of the point cloud bitstream is not to include the component information box.

In an example, the extension of the component information box is as follows:

| aligned(8) class AVSPCCComponentInfoBox | |
|---|---|
| extends FullBox(‘acif’, version = 0, 0) { | |
| unsigned int(4) avs_pcc_type; | |
| bit(4) reserved = 0; | |
| if(avs_pcc_type == 4) { | |
| unsigned int(8) | attr_num; |
| unsigned int(1) | multi_attr_type; |
| bit(6) | reserved = 0; |
| unsigned int(1) attr_group_info_flag; | |
| if(attr_group_info_flag == 1){ | |
| unsigned int(8) attr_group_id; | |
| } | |
| if(multi_attr_type == 0){ | |
| unsigned int(4) | attr_type; |
| bit(3) reserved = 0; | |
| } | |
| else{ | |
| for(i=0; i<attr_num; i++){ | |
| unsigned int(4) | attr_type; |

```
                bit(4) reserved = 0;
              }
        }
    }
}
```

The avs_pcc_type indicates the type of the component in the track, and has values shown in the following table 3.

TABLE 3
Type of the component

| Value of avs_pcc_type | Description |
|---|---|
| 0, 1 | Reserved |
| 2 | Geometry data |
| 3 | Reserved |
| 4 | Attribute data |
| 5 . . . 31 | Reserved |

The attr_num indicates a number of the attribute components included in the track.

A value of 0 for multi_attr_type indicates that the attribute components included in the component track are of a same attribute type. A value of 1 indicates that the attribute components included in the component track are of different attribute types.

The attr_type indicates the type of the attribute component included in the track. A value of 0 indicates a color attribute. A value of 1 indicates a reflectivity attribute.

A value of 0 for attr_group_info_flag indicates that the attribute group information is not indicated. A value of 1 indicates that the attribute group information is indicated, and the attribute component included in a current component track belong to a corresponding attribute group.

The attr_group_id indicates the identifier of the attribute group. Different attribute data belonging to a same attribute group have the encoding and decoding dependency relationships or the presentation dependency relationship.

The attr_group_info_flag may be understood as the attribute group information flag, and attr_num may be understood as the first attribute component number indication information.

In another example, the extension of the component information box is as follows:

| aligned(8) class AVSPCCComponentInfoBox | |
|---|---|
| extends FullBox(‘acif’, version = 0, 0) { | |
| unsigned int(4) avs_pcc_type; | |
| bit(4) reserved = 0; | |
| if(avs_pcc_type == 4) { | |
| unsigned int(4) | attr_type_num; |
| bit(3) | reserved = 0; |
| unsigned int(1) attr_group_info_flag; | |
| if(attr_group_info_flag == 1){ | |
| unsigned int(8) attr_group_id; | |
| } | |
| for(i=0; i<attr_type_num; i++){ | |
| unsigned int(4) | attr_type[i]; |
| bit(4) reserved = 0; | |
| unsigned int(8) | attr_num[i]; |

```
      }
  }
}
```

The attr_type_num indicates the number of types of the attribute components included in the track.

The attr_type[i] indicates the type of the attribute component included in the track. A value of 0 indicates a color attribute. A value of 1 indicates a reflectivity attribute.

The attr_num[i] indicates a number of a corresponding type of attribute components included in the track.

The attr_type_num may be understood as attribute component type number indication information, and attr_num[i] may be understood as second attribute component number indication information.

In some embodiments, if the attribute group information flag indicates attribute group information, and the attribute component included in the first track belongs to a corresponding second attribute group, the file decapsulation device determines an identifier of the second attribute group, and acquires attribute data from the second attribute group based on the identifier of the second attribute group. The second attribute group includes the first attribute data and the second attribute data. The attribute data in the second attribute group are decoded and presented together.

To be specific, in this embodiment, if attr_group_info_flag=1, the first track includes an attribute group, and the attribute components included in the first track belong to the second attribute group, the attribute data in the second attribute group have the presentation association relationship. The file decapsulation device continues to parse the component information box to acquire the identifier attr_group_id of the second attribute group. Attribute data included in the second attribute group may be acquired based on the identifier attr_group_id of the second attribute group, and the attribute data include the first attribute data and the second attribute data. Further, the attribute data included in the second attribute group are decoded and presented together.

The extended component information box of the embodiment of this application does not indicate the type of each attribute component included in the track one by one when indicating the type of each attribute component included in the track. Instead, the extended component information box indicates the number of the types of attribute components included in the track and the number of the attribute components included in each type, so as to simplify the indication information.

In some embodiments, if the attribute component in the point cloud bitstream is encapsulated in a second track, and the dependency indication information includes at least one of third information and fourth information, S102 includes the following operations S102-B1 to S102-B2:

S102-B1: Determine the first attribute group to which the first attribute data belong, the second track being the track encapsulating the point cloud bitstream in the single-track encapsulation mode or the slice track encapsulating all the components of the specific slice of the point cloud bitstream.

S102-B2: Determine at least one of the third information and the fourth information that correspond to the first attribute group, the third information being configured for indicating whether the decoding dependency relationship exists between attribute components in the first attribute group, and the fourth information being configured for indicating whether the presentation association relationship exists between the attribute components in the first attribute group.

In this embodiment, if the point cloud bitstream adopts the single-track encapsulation, to be specific, the geometry data and attribute data of the point cloud bitstream are encapsulated in one track, or the point cloud bitstream adopts the slice-based multi-track encapsulation, and all components of a specific slice in the point cloud bitstream are encapsulated in one slice track, this track is referred to as the second track for convenience of description. As may be seen from the content above, when the single-track encapsulation is adopted or the attribute data of the point cloud bitstream are encapsulated in one track, the attribute data that have the first relationship in the point cloud bitstream are divided into a same attribute group. Based on this, if the attribute component in the point cloud bitstream is encapsulated in a second track, the first attribute group to which the first attribute data belong is determined at first.

The embodiment of this application does not limit a specific method of determining the first attribute group to which the first attribute data belong.

In some embodiments, the second track includes description information of the attribute group. The description information of the attribute group includes information describing the identifier and the data type of each attribute group included in the second track, and then the attribute group where the first attribute data are located is determined based on the description information of the attribute group.

In some embodiments, S102-B1 includes the following operations S102-B11 to S102-B13:

S102-B11: Determine an attribute group flag corresponding to a first sub-sample where the first attribute data are located, the attribute group flag being configured for indicating whether the first sub-sample belongs to an attribute group.

S102-B12: Determine, if the attribute group flag indicates that the first sub-sample belongs to the attribute group, an identifier of the first attribute group to which the first sub-sample belongs.

S102-B13: Determine the first attribute group based on the identifier of the first attribute group.

In this implementation, the attribute group flag corresponding to the first sub-sample where the first attribute data are located is determined, and the attribute group flag is configured for indicating whether the first sub-sample belongs to the attribute group. If the first sub-sample belongs to the attribute group, the identifier of the first attribute group to which the first sub-sample belongs is determined, and then the first attribute group is determined based on the identifier of the first attribute group.

In some embodiments, the attribute group flag may be denoted by a field attr_group_flag.

In some embodiments, the identifier of the attribute group may be denoted by a field attr_group_id.

The embodiment of this application does not limit specific positions of the attribute group flag and the identifier of the attribute group in the point cloud file. In some embodiments, at least one of the attribute group flag and the identifier of the first attribute group is included in a sub-sample information box of the first sub-sample.

In the embodiment of this application, a definition of the sub-sample is extended. Each point cloud sample may be divided into one or more point cloud sub-samples. A SubSampleInformationBox is used during point cloud data encapsulation, and the sub-sample is defined according to values of flags of sub-sample information data. The flags specify a type of sub-sample information in this box as follows:

0: the sub-sample based on the type of the point cloud data. One sub-sample includes merely one data type defined by AVSPCCPayloadType.

1: a slice-based sub-sample. One sub-sample includes merely relevant information of one slice. When a corresponding track includes the component information box, the sub-sample of the corresponding track includes merely the component data corresponding to the corresponding component information box. When the corresponding track does not include the component information box, the sub-sample of the corresponding track includes all component data.

Other flag values are reserved.

The definition of the sub-sample is extended as follows:

A field codec_specific_parameters of SubsampleInformationBox is defined as follows:

| if(flags == 0){ | |
|---|---|
| unsined int(4) AVSPCCPayloadType; | |
| if(payloadType==2){ | |
| unsigned int(4) attr_type; | |
| unsigned int(1) attr_group_flag; | |
| if(attr_group_flag == 1){ | |
| unsigned int(8) attr_group_id; | |
| bit(15) | reserved = 0; |
| } | |
| else | |
| bit(23) reserved = 0; | |
| else{ | |
| bit(28) | reserved = 0; |
| } | |
| else if(flags == 1){ | |
| unsigned int(1) slice_data; | |
| if(slice_data==1){ | |
| unsigned int(24) | slice_id; |
| bit(7) | reserved = 0; |
| } | |
| else | |
| bit(31) | reserved = 0; |

}

The AVSPCCPayloadType indicates types of the point cloud data included in the sub-sample, and the value definition is shown in the following table 4:

TABLE 4
Types of the point cloud data

| payloadType value | Description |
|---|---|
| 0 | Sequence header |
| 1 | Geometry header |
| 2 | Geometry data of the slice |
| 3 | Attribute header |
| 4 | Attribute data of the slice |
| 5 . . . 31 | Reserved |

The attr_type indicates the type of attribute data included in the sub-sample. A value of 0 indicates a color attribute. A value of 1 indicates a reflectivity attribute.

The slice_data indicates whether the sub-sample includes the data of the slice. A value of 1 indicates inclusion of the geometry and/or attribute type data of the slice. A value of 0 indicates inclusion of parameter information of the point cloud.

The slice_id indicates an identifier of the slice corresponding to the data included in the sub-sample.

A value of 0 for attr_group_flag indicates that the sub-sample does not belong to the attribute group. A value of 1 indicates that the sub-sample belongs to the attribute group.

The attr_group_id indicates the identifier of the attribute group. Different attribute data belonging to a same attribute group have the encoding and decoding dependency relationships or the presentation dependency relationship.

To be specific, when the single-track encapsulation is adopted or the point cloud attribute data are encapsulated in one track, the file decapsulation device acquires the attribute group flag corresponding to the first sub-sample by parsing the sub-sample information box of the first sub-sample where the first attribute data are located in the second track. If the attribute group flag indicates that the first sub-sample belongs to the attribute group, the file decapsulation device continues to parse the sub-sample information box to acquire the identifier of the first attribute group to which the first sub-sample belongs, and further determines the first attribute group based on the identifier.

Next, at least one of the third information and the fourth information that correspond to the first attribute group is determined.

The embodiment of this application does not limit specific expression forms of the third information and the fourth information.

In some embodiments, the third information includes an attribute dependency group flag attr_dependency_group_flag, the fourth information includes a default attribute flag default_attr_flag, the attribute dependency group flag attr_dependency group_flag is configured for indicating whether the decoding dependency relationship exists between attribute components corresponding to the first attribute group, and the default attribute flag default_attr_flag is configured for indicating whether the attribute components corresponding to the first attribute group are default presented attribute components.

The embodiment of this application does not limit specific positions of the third information and the fourth information in the point cloud file.

In some embodiments, at least one of the third information and the fourth information may be included in the sub-sample information box of the first sub-sample.

In some embodiments, the embodiment of this application adds an attribute group information box to the second track, and the attribute group information box is configured to indicate the information related to the attribute group.

Exemplarily, the attribute group information box is defined as follows:

```
  Type of the box: ‘agin’
  Included in: SampleEntry
  Compulsory: No
  Number: 0 or 1
aligned(8) class GPCCMultiAttrInsInfoBox extends
FullBox(‘gmai’, 0, 0){
    unsigned int(8) attr_group_num;
    for (i=0; i<attr_group_num; i++) {
        unsigned int(8) attr_group_id;
        unsigned int(1) default_attr_group_flag;
        unsigned int(1) attr_dependency_group_flag;
        unsigned int(1) attr_group_label_flag;
        bit(5) reserved = 0;
        if(attr_group_label_flag == 1){
          utf8string attr_group_label;
        }
      }
}
```

The attr_group_num indicates a number of attribute groups included in a point cloud bit stream corresponding to a current track.

The attr_group_id indicates the identifier of a corresponding attribute group.

For default_attr_flag, a value of 1 for this field indicates that an attribute component corresponding to a current attribute group is an attribute component presented by default among the attribute components of a corresponding type. A value of 0 for this field indicates that the attribute component corresponding to the current attribute group is not the attribute component presented by default among a plurality of attribute components of a same type.

A value of 1 for attr_dependency_group_flag indicates that the encoding and decoding dependency relationships between the attribute components corresponding to the current attribute group. A value of 0 indicates that the encoding and decoding dependency relationships do not exist between the attribute components corresponding to the current attribute group.

A value of 1 for attr_group_label_flag indicates a descriptive label corresponding to the current attribute group. A value of 0 does not indicate the descriptive label corresponding to the current attribute group.

The attr_group_label indicates description information of the current attribute group.

The default_attr_flag may be understood as the presentation dependency flag, and attr_dependency_group_flag may be understood as the decoding dependency flag.

In some embodiments, for scenarios where the attribute data are located in different tracks, fields in the attribute group information box may be directly included in the component information box without using the attribute group information box, with extension as below.

| aligned(8) class AVSPCCComponentInfoBox | |
|---|---|
| extends FullBox(‘acif’, version = 0, 0) { | |
| unsigned int(4) avs_pcc_type; | |
| bit(4) reserved = 0; | |
| if(avs_pcc_type == 4) { | |
| unsigned int(4) | attr_type_num; |
| bit(3) | reserved = 0; |
| unsigned int(1) attr_group_info_flag; | |
| if(attr_group_info_flag == 1){ | |
| unsigned int(8) attr_group_id; | |
| unsigned int(1) default_attr_group_flag; | |
| unsigned int(1) attr_group_label_flag; | |
| bit(6) reserved = 0; | |
| if(attr_group_label_flag == 1){ | |
| utf8string attr_group_label; | |
| } | |
| } | |
| for(i=0; i<attr_type_num; i++){ | |
| unsigned int(4) | attr_type[i]; |
| bit(4) reserved = 0; | |
| unsigned int(8) | attr_num[i]; |

```
    }
  }
}
```

In the embodiment of this application, the file decapsulation device determines the at least one of the third information and the fourth information, and then may determine whether the first relationship exists between the first attribute data and the second attribute data. For example, if the third information indicates that the decoding dependency relationship exits between the attribute components in the first attribute group, for example, attr_dependency_group_flag=1, it is determined that the first attribute data depend on the second attribute data when decoded. For example, if the third information indicates that the decoding dependency relationship does not exists between the attribute components in the first attribute group, for example, attr_dependency_group_flag=0, it is determined that the first attribute data do not depend on the second attribute data when decoded.

Based on the operations described above, the file decapsulation device performs operation S103 after determining the dependency indication information of the first attribute data as below.

S103: Decode the first attribute data based on the dependency indication information.

In the embodiment of this application, the file encapsulation device encapsulates the attribute data that have the first relationship in one track or divides same into one attribute group. In this way, when decoding the first attribute data, the file decapsulation device determines the dependency indication information of the first attribute data based on the operations at first, so as to determine whether the first attribute data depend on the second attribute data when decoded.

In some embodiments, if the dependency indication information indicates that the decoding dependency relationship exists between the first attribute data and the second data, the file decapsulation device determines the second attribute data and decodes the first attribute data based on the second attribute data.

A mode of determining the second attribute data at least includes the following cases:

Case 1: if the point cloud bitstream adopts multi-track encapsulation, a first track where the first attribute data are located is determined, and it is determined that other attribute data except the first attribute data in the first track are the second attribute data. For example, if the point cloud bitstream adopts the component-based multi-track encapsulation, it is determined that other attribute data except the first attribute data in the component track where the first attribute data are located are the second attribute data. For example, if the point cloud bitstream adopts the slice-based multi-track encapsulation, it is determined that other attribute data except the first attribute data in the slice track where the first attribute data are located are the second attribute data.

For example, as shown in FIG. 7A, if the component-based multi-track encapsulation is adopted, the point cloud bitstream may be encapsulated in a plurality of component tracks, for example, one geometry component track and N attribute component tracks. Each component track includes a component information box. The file decapsulation device determines the first track where the first attribute data are located at first, such as the attribute component track 1, further determines at least one piece of the first information from the component information box of the attribute component track 1, and further determines a number of the attribute components included in the attribute component track 1 based on the first information. If the number of the attribute components included in the attribute component track 1 is greater than 1, it is determined that the first attribute data depend on the second attribute data when decoded, and the entire attribute component track 1 is further decoded to acquire the decoded first attribute data. If the number of the attribute components included in the attribute component track 1 is equal to 1, it is determined that the first attribute data do not depend on the second attribute data when decoded, and the first attribute data may be decoded independently to acquire the decoded first attribute data.

Case 2: If the attribute component in the point cloud bitstream is encapsulated in one second track, the first attribute group to which the first attribute data belong is determined, and it is determined that other attribute data except the first attribute data in the first attribute group are the second attribute data. For example, if the point cloud bitstream adopts the single-track encapsulation, the first attribute group to which the first attribute data belong is determined from the single track, and it is determined that other attribute data except the first attribute data in the first attribute group are the second attribute data. For example, if the point cloud bitstream adopts the slice-based multi-track encapsulation, and all components of a specific slice of the point cloud bitstream are encapsulated in one slice track, the first attribute group to which the first attribute data belong is determined from the slice track, and it is determined that other attribute data except the first attribute data in the first attribute group are the second attribute data.

Exemplarily, as shown in FIG. 7B, if the component-based single-track encapsulation is adopted, the geometry data and the attribute data of the point cloud bitstream may be encapsulated in one track. Specifically, different regions of the point cloud bitstream are encapsulated in different sub-samples. For example, the geometry component data, attribute component data 1, attribute component data 2, attribute component data 4, and attribute component data 5 of the point cloud bitstream are encapsulated in one sample 1, and the attribute component data 2 and the attribute component data 3 in the sample 1 have the first relationship, and then are divided into a same attribute group. For example, the attribute component data 2 and the attribute component data 3 are divided into an attribute group 1, and the attribute component data 2 and the attribute component data 3 are identified as belonging to the attribute group 1, to be specific, as attr_group_id=1. When decoding the first attribute data, the file decapsulation device determines the first sub-sample where the first attribute data are located at first, and then determines whether the first sub-sample belongs to the attribute group. If the first sub-sample belongs to the attribute group, the identifier of the first attribute group included in the first sub-sample is determined, and it is determined by assumption that the identifier of the first attribute group is attr_group_id=1. Then, the at least one of the third information and the fourth information that correspond to the first attribute group is determined from the description information of attribute groups included in the attribute group information box, and then whether the first relationship exists between the first attribute data and the second attribute data is determined based on the at least one of the third information and the fourth information that correspond to the first attribute group. For example, the third information includes attr_dependency_group_flag. If attr_dependency_group_flag=1, it is determined that the first attribute data depend on the second attribute data when decoded, then the second attribute data are determined from the first attribute group, and the first attribute data are decoded based on the second attribute data. For example, if the second information indicates that the decoding dependency relationship does not exist between the attribute components in the first attribute group, for example, attr_dependency_group_flag=0, it is determined that the first attribute data do not depend on the second attribute data when decoded, and then the first attribute data are separately decoded.

In some embodiments, if the dependency indication information indicates that the decoding dependency relationship does not exist between the first attribute data and the second attribute data, the first attribute data are separately decoded. For example, as may be seen from the contents above, if the encoding dependency relationship does not exist between the first attribute data and the second attribute data, the file encapsulation device separately encapsulates the first attribute data in one track when the multi-track encapsulation, and the file encapsulation device regards the first attribute data as a separate attribute component and does not divide the first attribute data into the attribute group when the single-track encapsulation. In this way, when performing decapsulation, the file decapsulation device decapsulates and decodes the track where the first attribute data are located when the multi-track encapsulation to acquire the decoded first attribute data, and separately decodes the first attribute data when the single-track encapsulation to acquire the decoded first attribute data.

In some embodiments, if the dependency indication information indicates that the presentation association relationship exists between the first attribute data and the second attribute data, the second attribute data are determined, and the first attribute data and the second attribute data are decoded and presented together.

In some embodiments, if the dependency indication information indicates that the presentation association relationship does not exist between the first attribute data and the second attribute data, the first attribute data are separately presented.

In the embodiment of this application, the first attribute data are correctly decoded by determining the dependency indication information of the first attribute data, and the decoded first attribute data are presented. Thus, correct decoding and personalized presentation of some attribute data in the point cloud bitstream are implemented.

According to the method for decapsulating a point cloud file provided by the embodiment of this application, the to-be-decoded first attribute data is determined from the point cloud file. The dependency indication information of the first attribute data is determined, the dependency indication information is configured for indicating whether the first relationship exists between the first attribute data and the second attribute data, and the first relationship includes at least one of the decoding dependency relationship and the presentation association relationship. The first attribute data are further decoded based on the dependency indication information. To be specific, according to this application, encoding and decoding dependency relationships or the presentation association relationship between different point cloud attribute data is indicated with the dependency indication information, thus supporting partial access, the correct decoding, and the personalized presentation of the point cloud bitstream.

The method for decapsulating a point cloud file is described above, and the method for encapsulating a point cloud file is described below.

FIG. 8 is a flowchart of the method for encapsulating a point cloud file according to an embodiment of this application. As shown in FIG. 8, the method includes the following operations:

S201: Acquire a point cloud bitstream.

The point cloud bitstream including N groups of attribute data, and N being a positive integer.

In the embodiment of this application, point cloud data are encoded to acquire the point cloud bitstream. In some embodiments, the point cloud bitstream is also referred to as a point cloud bit stream. The point cloud includes geometry information and attribute information. The geometry information is encoded to acquire a geometry bit stream (or referred to as the geometry bitstream), and the attribute information is encoded to acquire an attribute bit stream (or referred to as attribute bitstream). The point cloud bitstream of the embodiment of this application includes at least the attribute bitstream. For example, the point cloud bitstream of the embodiment of this application includes the geometry bitstream and the attribute bitstream, or the point cloud bitstream of the embodiment of this application includes merely the attribute bitstream.

In some embodiments, the point cloud bitstream of the embodiment of this application includes the geometry data and the N groups of attribute data, and N is the positive integer. The geometry data may be understood as the geometry bitstreams, and the attribute data may be understood as the attribute bitstreams.

S202: Encapsulate, for to-be-encapsulated first attribute data in the N groups of attribute data, the first attribute data based on a first relationship between the first attribute data and second attribute data, determine dependency indication information of the first attribute data, and acquire the point cloud file.

The dependency indication information being configured for indicating whether the first relationship exists between the first attribute data and the second attribute data, and the first relationship including at least one of an encoding dependency relationship and a presentation association relationship.

In the embodiment of this application, a point cloud encapsulation device (such as a server) encapsulates the point cloud bitstream after acquiring the point cloud bitstream, so as to acquire the point cloud file.

According to the embodiment of this application, when the to-be-encapsulated first attribute data in the N groups of attribute data are encapsulated, the first attribute data are encapsulated based on the first relationship existing between the first attribute data and the second attribute data. The first attribute data may be any at least one group of to-be-encapsulated attribute data or parts of attribute data in one group of attribute data.

In the embodiment of this application, a specific method of encapsulating the first attribute data based on the first relationship between the first attribute data and the second attribute data is not limited.

In some embodiments, if the first attribute data and the second attribute data have the presentation dependency relationship, the first attribute data and the second attribute data are encapsulated in a same attribute track or divided into a same attribute group.

In some embodiments, if the first attribute data and the second attribute data do not have the presentation dependency relationship, the first attribute data and the second attribute data may be encapsulated in different attribute tracks. For example, the first attribute data may be encapsulated in one attribute track alone, or the first attribute data may be regarded as a separate attribute component and not identifying as belonging to the one attribute group.

In some embodiments, if the dependency indication information indicates that the encoding dependency relationship does not exist between the first attribute data and the second attribute data, the first attribute data are separately encapsulated. For example, the first attribute data are separately encapsulated in one track when multi-track encapsulation, and the first attribute data are regarded as the separate attribute component and are not divided into the attribute group when single-track encapsulation.

In some embodiments, if the encoding dependency relationship exists between the first attribute data and the second attribute data, S202 includes the following operations S202-A1 to S202-A2:

S202-A1: Acquire the second attribute data.

S202-A2: Encapsulate the first attribute data based on the second attribute data.

As may be seen from the contents above, the point cloud encapsulation device encapsulates the point cloud bitstream in a mode including at least single-track encapsulation, component-based multi-track encapsulation, and slice-based multi-track encapsulation. In this case, S202-A2 includes the following several methods:

In some embodiments, if the point cloud bitstream adopts the component-based multi-track encapsulation, the second attribute data and the first attribute data are encapsulated in a first track.

To be specific, in this embodiment, if the point cloud encapsulation device adopts the component-based multi-track encapsulation, the point cloud attribute data that have the first relationship in the point cloud bitstream may be encapsulated in a same component track. In this way, when decoding, a decoding end may decode merely the attribute data in the same component track, so as to partially access and correctly decode the point cloud attribute data, and further implement personalized presentation of the point cloud attribute data. For example, the point cloud bitstream includes the geometry data and the N groups of attribute data. The point cloud encapsulation device may encapsulate the geometry data in a separate component track, encapsulate M groups of attribute data that have a first relationship therebetween among the N groups of attribute data in a same attribute component track, and encapsulate 1 group of attribute data that does not have the first relationship with other attribute data among the N groups of attribute data in a separate attribute component track.

Alternatively, if the point cloud encapsulation device adopts slice-based multi-track encapsulation, for a specific slice, the point cloud attribute data that have the first relationship in the point cloud bitstream may be encapsulated in a same component track. In this way, when decoding, the decoding end may decode merely the attribute data in the same slice track, so as to partially access and correctly decode the point cloud attribute data, and further implement personalized presentation of the point cloud attribute data. For example, geometry data and attribute data corresponding to the specific slice are located in a plurality of different slice tracks. For example, the geometry data are encapsulated in a separate slice track, M groups of attribute data that have the first relationship therebetween among the N groups of attribute data are encapsulated in one slice track, and 1 group of attribute data that does not have the first relationship with other attribute data among the N groups of attribute data are encapsulated in a separate slice track.

During the multi-track encapsulation, the attribute data that have the first relationship are encapsulated in one track. For example, if the point cloud bitstream adopts the component-based multi-track encapsulation, the second attribute data and the first attribute data are encapsulated in a first component track. For example, if the point cloud bitstream adopts the slice-based multi-track encapsulation, the second attribute data and the first attribute data are encapsulated in a first slice track.

In the embodiment of this application, after the first attribute data and the second attribute data are encapsulated in the first track, the dependency indication information of the first attribute data need to be further determined.

The embodiment of this application does not limit a specific method of determining the dependency indication information of the first attribute data.

In some embodiments, a flag is separately set to indicate whether the first attribute data depend on the second attribute data when encoded or presented.

In some embodiments, if the point cloud bitstream adopts the component-based multi-track encapsulation, the dependency indication information includes at least one of first information and second information, and S202 that dependency indication information of the first attribute data is determined includes the following operation S202-B1:

S202-B1: Determine at least one of first information and second information that correspond to the first track, the first information being configured for indicating a number of attribute components included in the first track, and the second information being configured for indicating whether the first track includes an attribute group.

For example, if the encoding dependency relationship exists between the first attribute data and the second attribute data, the first information is determined to indicate that the number of the attribute components included in the first track is greater than 1.

If the encoding dependency relationship does not exist between the first attribute data and the second attribute data, the first information is determined to indicate that the number of the attribute components included in the first track is equal to 1.

If the presentation association relationship exists between the first attribute data and the second attribute data, it is determined that the second information indicates that the first track includes the attribute group.

If the presentation association relationship does not exist between the first attribute data and the second attribute data, it is determined that the second information indicates that the first track does not include the attribute group.

The embodiment of this application does not limit a specific expression form of the first information.

In some embodiments, the first information includes first attribute component number indication information, the first attribute component number indication information being configured for indicating the number of the attribute components included in the first track.

In some embodiments, the first information includes attribute component type number indication information and second attribute component number indication information, the attribute component type number indication information being configured for indicating a number of different types of the attribute components included in the first track, and the second attribute component number indication information being configured for indicating a number of attribute components of each type.

In some embodiments, the second information includes an attribute group information flag, the attribute group information flag indicating whether to indicate attribute group information.

In some embodiments, if the presentation association relationship exists between the first attribute data and the second attribute data, and the first attribute data and the second attribute data are divided into a second attribute group, the file encapsulation device further determines an identifier of the second attribute group, and further adds the identifier of the second attribute group to the point cloud file.

The embodiment of this application does not limit specific positions of the first information and the second information in the point cloud file.

In some embodiments, the first information and the second information are included in a component information box in the first track.

In the embodiment of this application, the component information box is extended to support implementation operations of this application with details as below.

Extension of the component information box
Type of the box: ‘acif’
Included in: sample entry
Compulsory: No
Number: 0 or 1

The component information box indicates the data type of the point cloud component, namely, geometry, attributes, etc. When the box is included in the sample entry of the track, the box indicates the type of the point cloud component carried in a corresponding track. The box also provides information related to the attribute data in the attribute component track. However, when the point cloud bitstream is stored in a single-track mode, a sample entry of the point cloud bitstream is not to include the component information box.

In an example, the extension of the component information box is as follows:

| aligned(8) class AVSPCCComponentInfoBox | |
|---|---|
| extends FullBox(‘acif’, version = 0, 0) { | |
| unsigned int(4) avs_pcc_type; | |
| bit(4) reserved = 0; | |
| if(avs_pcc_type == 4) { | |
| unsigned int(8) | attr_num; |
| unsigned int(1) | multi_attr_type; |
| bit(6) | reserved = 0; |

```
    unsigned int(1) attr_group_info_flag;
    if(attr_group_info_flag == 1){
      unsigned int(8) attr_group_id;
    }
    if(multi_attr_type == 0){
        unsigned int(4) attr_type;
            bit(3) reserved = 0;
    }
    else{
        for(i=0; i<attr_num; i++){
              unsigned int(4) attr_type;
              bit(4) reserved = 0;
          }
    }
  }
}
```

The avs_pcc_type indicates the type of the component in the track, and has values shown in the following table 3.

The attr_num indicates a number of the attribute components included in the track.

A value of 0 for multi_attr_type indicates that the attribute components included in the component track are of a same attribute type. A value of 1 indicates that the attribute components included in the component track are of different attribute types.

The attr_type indicates the type of the attribute component included in the track. A value of 0 indicates a color attribute. A value of 1 indicates a reflectivity attribute.

A value of 0 for attr_group_info_flag indicates that the attribute group information is not indicated. A value of 1 indicates that the attribute group information is indicated, and the attribute component included in a current component track belong to a corresponding attribute group.

The attr_group_id indicates the identifier of the attribute group. Different attribute data belonging to a same attribute group have the encoding and decoding dependency relationships or the presentation dependency relationship.

The attr_num may be understood as the first attribute component number indication information, and attr_group_info_flag may be understood as an attribute group information flag.

In another example, the extension of the component information box is as follows:

| aligned(8) class AVSPCCComponentInfoBox | |
|---|---|
| extends FullBox(‘acif’, version = 0, 0) { | |
| unsigned int(4) avs_pcc_type; | |
| bit(4) reserved = 0; | |
| if(avs_pcc_type == 4) { | |
| unsigned int(4) | attr_type_num; |
| bit(3) | reserved = 0; |
| unsigned int(1) attr_group_info_flag; | |
| if(attr_group_info_flag == 1){ | |
| unsigned int(8) attr_group_id; | |
| } | |
| for(i=0; i<attr_type_num; i++){ | |
| unsigned int(4) attr_type[i]; | |
| bit(4) reserved = 0; | |
| unsigned int(8) | attr_num[i]; |

```
    }
  }
}
```

The attr_type_num indicates the number of types of the attribute components included in the track.

The attr_type[i] indicates the type of the attribute component included in the track. A value of 0 indicates a color attribute. A value of 1 indicates a reflectivity attribute.

The attr_num[i] indicates a number of a corresponding type of attribute components included in the track.

The attr_type_num may be understood as attribute component type number indication information, and attr_num[i] may be understood as second attribute component number indication information.

In the embodiment of this application, when the component-based multi-track encapsulation, when the point cloud bitstream performs file encapsulation in a multi-track mode, different components in the point cloud bitstream are encapsulated in a plurality of file tracks, to be specific, component tracks. The component tracks include a point cloud geometry track and a point cloud attribute track. Each sample in the component track includes one or more slices of a same type.

In the multi-track encapsulation mode, the component track is to satisfy the following constraints:

a) One geometry component track is to be included and the geometry component track serves as an access point.

b) Zero or more attribute component tracks may be included, and a field track_in_movie in the component tracks is to be set as 0.

c) The sample entry of each component track needs to include an component information box AVSPCCComponentInfoBox configured to indicate a point cloud component data type included in the component track.

d) The geometry component track is associated with a corresponding attribute component track through a track index.

e) A plurality of attribute components that have the encoding and decoding dependency relationships are to be included in a same attribute component track.

Timing alignment between different component tracks of a same point cloud sequence is implemented. Different component track samples corresponding to a same point cloud frame are to have same presentation time. When a parameter set exists in the track sample, decoding time of the parameter set is to be equal to or earlier than decoding time of corresponding point cloud component data. When all parameter sets of all component tracks are included in the track sample, a sample including a sequence header parameter set is to be equal to or earlier than a sample including a geometry header parameter set or an attribute header parameter set. In addition, all component tracks of the same point cloud sequence are to have a same implicitly or explicitly indicated edition list.

When the point cloud bitstream includes a plurality of slices, based on the slices, the point cloud bitstream may be encapsulated as a plurality of tracks including a slice basic track and a slice track.

In the slice-based multi-track encapsulation mode, the slice basic track and the slice track are to satisfy the following constraints:

a) One slice basic track is to be included. The slice basic track includes all geometry header sets and the attribute header parameter sets in the point cloud bitstream, and the slice basic track serves as the access point.

b) One or more slice tracks are included.

c) The slice basic track is associated with a corresponding slice track through a track index.

When different components of the slice are encapsulated in different slice tracks, one or more slice tracks including the geometry component data are to be included, and zero, one or more slice tracks including the attribute component data may exist. A value of the field track_in_movie of the slice track including the attribute component data is to be equal to 0. In addition, the plurality of attribute components that have the encoding and decoding dependency relationships are to be included in a same slice track including the attribute component data.

For example, as shown in FIG. 7A, if the component-based multi-track encapsulation is adopted, the point cloud bitstream may be encapsulated in a plurality of component tracks, for example, one geometry component track and N attribute component tracks. Each component track includes one component information box. The component information box is configured to indicate a type of the point cloud component included in a current track. If the type is the attribute component, a number, a type, etc. of the attribute component are indicated.

When the multi-track encapsulation, each attribute component track does not depend on other attribute component tracks when encoded and decoded. Through information in the component information box, label information of different attribute component tracks may be acquired. In some embodiments, the track sample entry includes the attribute group information box to further acquire the label information of the attribute group, to be specific, the presentation relationship between different attribute components. In this way, a decoder may select and present a required attribute component track according to metadata information.

In some embodiments, if an attribute component in the point cloud bitstream is encapsulated in a second track, the first attribute data and the second attribute data are identified as belonging to a first attribute group, the second track being a track encapsulating the point cloud bitstream in a single-track encapsulation mode or a slice track encapsulating all components of a specific slice of the point cloud bitstream.

To be specific, in the embodiment of this application, if the point cloud encapsulation device adopts the single-track encapsulation, or all components of the specific slice of the point cloud bitstream are encapsulated in one slice track, the point cloud attribute data that have the first relationship may be divided into the same attribute group. In this way, when decoding, the decoding end may decode merely the attribute data belonging to the same attribute group, so as to partially access and correctly decode the point cloud attribute data, and further implement personalized presentation of the point cloud attribute data.

In some embodiments, the embodiment of this application further includes: determine an attribute group flag corresponding to a first sub-sample where the first attribute data are located, the attribute group flag being configured for indicating whether the first sub-sample belongs to an attribute group; determine, if the attribute group flag indicates that the first sub-sample belongs to the attribute group, an identifier of the first attribute group to which the first sub-sample belongs; and encapsulate the attribute group flag and the identifier of the first attribute group in the second track.

In some embodiments, the attribute group flag may be denoted by a field attr_group_flag.

In some embodiments, the identifier of the attribute group may be denoted by a field attr_group_id.

The embodiment of this application does not limit specific positions of the attribute group flag and the identifier of the attribute group in the point cloud file. In some embodiments, at least one of the attribute group flag and the identifier of the first attribute group is included in a sub-sample information box of the first sub-sample.

In the embodiment of this application, a definition of the sub-sample is extended. Each point cloud sample may be divided into one or more point cloud sub-samples. A SubSampleInformationBox is used during point cloud data encapsulation, and the sub-sample is defined according to values of flags of sub-sample information data. The flags specify a type of sub-sample information in this box as follows:

0: the sub-sample based on the type of the point cloud data. One sub-sample includes merely one data type defined by AVSPCCPayloadType.

1: a slice-based sub-sample. One sub-sample includes merely relevant information of one slice. When a corresponding track includes the component information box, the sub-sample of the corresponding track includes merely the component data corresponding to the corresponding component information box. When the corresponding track does not include the component information box, the sub-sample of the corresponding track includes all component data.

Other flag values are reserved.

The definition of the sub-sample is extended as follows:

| if(flags == 0){ | |
|---|---|
| unsined int(4) AVSPCCPayloadType; | |
| if(payloadType == 2){ | |
| unsigned int(4) attr_type; | |
| unsigned int(1) attr_group_flag; | |
| if(attr_group_flag == 1){ | |
| unsigned int(8) attr_group_id; | |
| bit(15) | reserved = 0; |
| } | |
| else | |
| bit(23) reserved = 0; | |
| } | |
| else{ | |
| bit(28) | reserved = 0; |
| } | |
| } | |
| else if(flags == 1){ | |
| unsigned int(1) slice_data; | |
| if(slice_data==1){ | |
| unsigned int(24) | slice_id; |
| bit(7) | reserved = 0; |
| } | |
| else | |
| bit(31) | reserved = 0; |

}

The AVSPCCPayloadType indicates types of the point cloud data included in the sub-sample, and the value definition is shown in the following table 4.

The attr_type indicates the type of attribute data included in the sub-sample. A value of 0 indicates a color attribute. A value of 1 indicates a reflectivity attribute.

The slice_data indicates whether the sub-sample includes the data of the slice. A value of 1 indicates inclusion of the geometry and/or attribute type data of the slice. A value of 0 indicates inclusion of parameter information of the point cloud.

The slice_id indicates an identifier of the slice corresponding to the data included in the sub-sample.

A value of 0 for attr_group_flag indicates that the sub-sample does not belong to the attribute group. A value of 1 indicates that the sub-sample belongs to the attribute group.

The attr_group_id indicates the identifier of the attribute group. Different attribute data belonging to a same attribute group have the encoding and decoding dependency relationships or the presentation dependency relationship.

To be specific, when the single-track encapsulation is adopted or the point cloud attribute data are encapsulated in one track, the file encapsulation device extends the sub-sample information box of the first sub-sample where the first attribute data are located in the second track, specifically by adding the attribute group flag corresponding to the first sub-sample. If the attribute group flag indicates that the first sub-sample belongs to the attribute group, the identifier of the attribute group to which the first sub-sample belongs is continuously added.

The file encapsulation device encapsulates the first attribute data and the second attribute data in the second track. After the first attribute data and the second attribute data are identified as belonging to the first attribute group, the dependency indication information of the first attribute data needs to be further determined.

In some embodiments, whether the first relationship exists between the first attribute data and the second attribute data are indicated by a flag bit.

In some embodiments, if the attribute component in the point cloud bitstream is encapsulated in a second track, and the dependency indication information includes at least one of third information and fourth information, S202 that dependency indication information of the first attribute data is determined includes the following operation S202-C1:

S202-C1: Determine the at least one of the third information and the fourth information that correspond to the first attribute group, the third information being configured for indicating whether the encoding dependency relationship exists between attribute components in the first attribute group, and the fourth information being configured for indicating whether the presentation association relationship exists between the attribute components in the first attribute group.

For example, if the first attribute data depend on the second attribute data when encoded, it is determined that the second information indicates that the attribute components in the first attribute group have the dependency relationship when encoded. If the first attribute data do not depend on the second attribute data when encoded, it is determined that the second information indicates that the attribute components in the first attribute group have no dependency relationship when encoded.

The embodiment of this application does not limit specific expression forms of the third information and the fourth information.

In some embodiments, the third information includes an attribute dependency group flag, the fourth information includes a default attribute flag, the attribute dependency group flag is configured for indicating whether the encoding dependency relationship exists between attribute components corresponding to the first attribute group, and the default attribute flag is configured for indicating whether the attribute components corresponding to the first attribute group are default presented attribute components.

The embodiment of this application does not limit specific positions of the third information and the fourth information in the point cloud file.

In some embodiments, the embodiment of this application adds an attribute group information box to the second track, and the attribute group information box is configured to indicate the information related to the attribute group. The at least one of the third information and the fourth information is not included in the attribute component information box in the second track.

Exemplarily, the attribute group information box is defined as follows:

| Type of the box: | ‘agin’ |
|---|---|
| Included in: | SampleEntry |
| Compulsory: | No |
| Number: 0 or 1 | |
| aligned(8) class GPCCMultiAttrInsInfoBox extends | |
| FullBox(‘gmai’, 0, 0){ | |
| unsigned int(8) attr_group_num; | |
| for (i=0; i<attr_group_num; i++) { | |
| unsigned int(8) | attr_group_id; |

```
        unsigned int(1) default_attr_group_flag;
        unsigned int(1) attr_dependency_group_flag;
        unsigned int(1) attr_group_label_flag;
        bit(5) reserved = 0;
        if(attr_group_label_flag == 1){
          utf8string attr_group_label;
        }
      }
}
```

The attr_group_num indicates a number of attribute groups included in a point cloud bit stream corresponding to a current track.

The attr_group_id indicates the identifier of a corresponding attribute group.

For default_attr_flag, a value of 1 for this field indicates that an attribute component corresponding to a current attribute group is an attribute component presented by default among the attribute components of a corresponding type. A value of 0 for this field indicates that the attribute component corresponding to the current attribute group is not the attribute component presented by default among a plurality of attribute components of a same type.

A value of 1 for attr_dependency_group_flag indicates that the encoding and decoding dependency relationships between the attribute components corresponding to the current attribute group. A value of 0 indicates that the encoding and decoding dependency relationships do not exist between the attribute components corresponding to the current attribute group.

A value of 1 for attr_group_label_flag indicates a descriptive label corresponding to the current attribute group. A value of 0 does not indicate the descriptive label corresponding to the current attribute group.

The attr_group_label indicates description information of the current attribute group.

The default_attr_flag may be understood as the presentation dependency flag, and attr_dependency_group_flag may be understood as the decoding dependency flag.

To be specific, the embodiment of this application introduces the attribute component information box configured to indicate the attribute component information.

In some embodiments, for scenarios where the attribute data are located in different tracks, fields in the attribute group information box may be directly included in the component information box without using the attribute group information box, with extension as below.

| aligned(8) class AVSPCCComponentInfoBox | |
|---|---|
| extends FullBox(‘acif’, version = 0, 0) { | |
| unsigned int(4) | avs_pcc_type; |
| bit(4) reserved = 0; | |
| if(avs_pcc_type == 4) { | |
| unsigned int(4) | attr_type_num; |
| bit(3) | reserved = 0; |
| unsigned int(1) attr_group_info_flag; | |
| if(attr_group_info_flag == 1){ | |
| unsigned int(8) attr_group_id; | |
| unsigned int(1) default_attr_group_flag; | |
| unsigned int(1) attr_group_label_flag; | |
| bit(6) reserved = 0; | |
| if(attr_group_label_flag == 1){ | |
| utf8string attr_group_label; | |
| } | |
| } | |
| for(i=0; i<attr_type_num; i++){ | |
| unsigned int(4) attr_type[i]; | |
| bit(4) reserved = 0; | |
| unsigned int(8) | attr_num[i]; |

```
    }
  }
```

In the embodiment of this application, if the attribute component in the point cloud bitstream is encapsulated in a second track, it is determined that other attribute data except the first attribute data in the first attribute group where the first attribute data are located are the second attribute data. For example, if the point cloud bitstream adopts the single-track encapsulation, the first attribute group where the first attribute data are located is determined from the single track, and it is determined that the other attribute data except the first attribute data in the first attribute group are the second attribute data. For example, if the point cloud bitstream adopts the slice-based multi-track encapsulation, and the attribute data of the point cloud bitstream are encapsulated in one slice track, the first attribute group where the first attribute data are located is determined from the slice track, and it is determined that other attribute data except the first attribute data in the first attribute group are the second attribute data. Further, the first attribute data and the second attribute data are divided into a same attribute group.

Exemplarily, as shown in FIG. 7B, if the component-based single-track encapsulation is adopted, the geometry data and the attribute data of the point cloud bitstream may be encapsulated in one track. Specifically, different regions of the point cloud bitstream are encapsulated in different sub-samples. For example, the geometry component data, attribute component data 1, attribute component data 2, attribute component data 4, and attribute component data 5 of the point cloud bitstream are encapsulated in one sample 1, and the attribute component data 2 and the attribute component data 3 in the sample 1 have the first relationship, and may be divided into a same attribute group, for example, into an attribute group 1. In addition, an identifier attr_group_id=1 of the attribute group 1 is added to both the attribute component data 2 and the attribute component data 3.

To be specific, when the single-track encapsulation is adopted or the attribute data in the point cloud bitstream are encapsulated in one single track, different attribute components may be divided by a method of the definition of the sub-sample. For example, the track sample entry includes the attribute group information box, such that information such as the encoding and decoding dependency relationships and the attribute label of the attribute group may be acquired. Thus, the encoding and decoding relationships and the presentation relationship between different attribute components may be acquired. According to the metadata information, the decoder may select and decode the required sub-sample.

The file encapsulation device adds corresponding metadata information according to an adopted specific encapsulation mode, so as to indicate necessary information required for decoding the file track.

Next, the file encapsulation device directly transmits the point cloud file F to a client according to a transmission mode between the file encapsulation device (such as the server) and the file decapsulation device (such as the client). Alternatively, the point cloud file F is sliced to acquire an Fs set, and file track data required by the user in a corresponding slice are transmitted to the user according to demand from the user.

In some embodiments, the embodiment of this application extends the DASH signaling, in particular the point cloud component descriptor. To be specific, the embodiment of this application further includes: determine point cloud component description information of the point cloud file, the point cloud component description information being configured for describing at least one of types of point cloud components, a type list of attribute components, a number list of attribute components of different types, an identifier of an attribute group to which the attribute component belongs, and description information of the attribute group that are included in tracks of the point cloud file.

The point cloud component description information is also referred to as a point cloud component descriptor (AVS PCC component descriptor), and may identify a type of the point cloud component in the component adaptation set. The point cloud component descriptor is an EssentialProperty element, and @solutionIdUri attribute is set as “urn:avs:pccs:2022:component”.

At an adaptation set level, each point cloud component in the representation of the component adaptation set is to be represented by one point cloud component descriptor.

Exemplarily, the point cloud component descriptor is to include elements and attributes defined in Table 2.

As may be seen from Table 2 above, in this embodiment of this application, the DASH signaling extension specifically indicates that the point cloud component descriptor is extended. When the type of the point cloud component is the attribute component, the number list of different types of attribute components, the identifier of the attribute group to which the attribute component belongs, and the description information of the attribute group are added. To be specific, in the embodiment of this application, if the value of component@type is ‘attr’, the point cloud component descriptor includes component@attr_type configured to indicate the type list of the attribute components, and further includes at least one of component@attr_num configured to indicate the number list of the attribute components of a corresponding type, component@attr_group_id indicating the identifier of the attribute group to which the point cloud attribute component belongs, and component@attr_group_label indicating the description information of the attribute group to which the point cloud attribute component belongs.

Based on this, the file decapsulation device determines the to-be-decoded first attribute data from the point cloud based on the received point cloud component description information (namely, the point cloud component descriptor).

According to the method for encapsulating a point cloud file provided by the embodiment of this application, the attribute data that have the first relationship in the point cloud bitstream are encapsulated in a same track or are divided a same attribute group. In addition, the dependency indication information is determined to indicate whether the first relationship exists between the attribute data, thus supporting partial access, correct decoding, and personalized presentation of the attribute data in the point cloud bitstream.

FIG. 6 to FIG. 8 are merely examples of this application and are not to be understood as limitation to this application.

The exemplary implementations of this application have been described above in detail with reference to the accompanying drawings, but this application is not limited to the specific details in the implementations. Various simple modifications can be made to the technical solution of this application within the technical concept of this application, and these simple modifications are to fall within the protection scope of this application. For example, specific technical features described in the specific implementations may be combined in different manners to form other implementations without contradiction, and various possible combinations will not be described otherwise in this application for avoiding unnecessary repetition. In addition, various different implementations of this application can also be combined in different manners to form other implementations, and the combinations are to be regarded as the contents in this application as long as they do not violate the idea of this application.

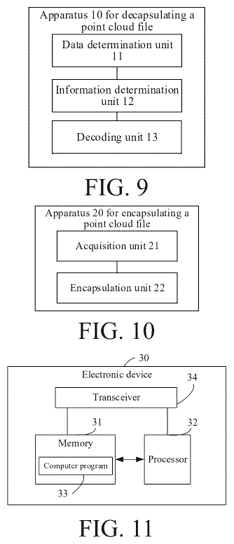

The method embodiment of this application is described in detail with reference to FIG. 6 to FIG. 8, and the apparatus embodiment of this application is described in detail with reference to FIG. 9 to FIG. 10 below.

FIG. 9 is a schematic structural diagram of an apparatus for decapsulating a point cloud file according to an embodiment of this application. The apparatus 10 for decapsulating a point cloud file includes:
a data determination unit 11 configured to determine to-be-decoded first attribute data from the point cloud file, the point cloud file being a file acquired by encapsulating a point cloud bitstream;
an information determination unit 12 configured to determine dependency indication information of the first attribute data, the dependency indication information being configured for indicating whether a first relationship exists between the first attribute data and second attribute data, and the first relationship including at least one of a decoding dependency relationship and a presentation association relationship; and
a decoding unit 13 configured to decode the first attribute data based on the dependency indication information.

In some embodiments, the decoding unit 13 is specifically configured to determine, if the dependency indication information indicates that the decoding dependency relationship exists between the first attribute data and the second attribute data, the second attribute data, and decode the first attribute data based on the second attribute data; and separately decode, if the dependency indication information indicates that the decoding dependency relationship does not exist between the first attribute data and the second attribute data, the first attribute data.

In some embodiments, the decoding unit 13 is specifically configured to determine a first track where the first attribute data are located, and determine that other attribute data except the first attribute data from the first track are the second attribute data if the point cloud bitstream adopts component-based multi-track encapsulation; and determine a first attribute group to which the first attribute data belong, and determine that other attribute data except the first attribute data from the first attribute group are the second attribute data if an attribute component in the point cloud bitstream is encapsulated in a second track, the second track being a track encapsulating the point cloud bitstream in a single-track encapsulation mode or a slice track encapsulating all components of a specific slice of the point cloud bitstream.

In some embodiments, if the point cloud bitstream adopts the component-based multi-track encapsulation, the dependency indication information includes at least one of first information and second information, and the information determination unit 12 is specifically configured to determine the first track where the first attribute data are located; and determine at least one of the first information and the second information that correspond to the first track, the first information being configured for indicating a number of attribute components included in the first track, and the second information being configured for indicating whether the first track includes an attribute group.

In some embodiments, if the first information indicates that the number of the attribute components included in the first track is greater than 1, the decoding dependency relationship exists between the first attribute data and the second attribute data.

If the first information indicates that the number of the attribute components included in the first track is equal to 1, the decoding dependency relationship does not exist between the first attribute data and the second attribute data.

If the second information indicates that the first track includes the attribute group, the presentation association relationship exists between the first attribute data and the second attribute data.

If the second information indicates that the first track does not include the attribute group, the presentation association relationship does not exist between the first attribute data and the second attribute data.

In some embodiments, the first information includes first attribute component number indication information, the first attribute component number indication information being configured for indicating the number of the attribute components included in the first track. Alternatively, the first information includes attribute component type number indication information and second attribute component number indication information, the attribute component type number indication information being configured for indicating a number of different types of the attribute components included in the first track, and the second attribute component number indication information being configured for indicating a number of attribute components of each type. The second information includes an attribute group information flag, the attribute group information flag indicating whether to indicate attribute group information.

In some embodiments, if the attribute group information flag indicates the attribute group information, and the attribute component included in the first track belongs to a corresponding second attribute group, the decoding unit 13 is further configured to determine an identifier of the second attribute group; acquire attribute data from the second attribute group based on the identifier of the second attribute group, the second attribute group including the first attribute data and the second attribute data; and decode the attribute data in the second attribute group and present the attribute data together.

In some embodiments, if the attribute component in the point cloud bitstream is encapsulated in the second track, and the dependency indication information includes at least one of third information and fourth information, the information determination unit 12 is specifically configured to determine the first attribute group to which the first attribute data belong, the second track being a track encapsulating the point cloud bitstream in a single-track encapsulation mode or a slice track encapsulating all components of a specific slice of the point cloud bitstream; and determine at least one of the third information and the fourth information that correspond to the first attribute group, the third information being configured for indicating whether the decoding dependency relationship exists between attribute components in the first attribute group, and the fourth information being configured for indicating whether the presentation association relationship exists between the attribute components in the first attribute group.

In some embodiments, the information determination unit 12 is specifically configured to determine an attribute group flag corresponding to a first sub-sample where the first attribute data are located, the attribute group flag being configured for indicating whether the first sub-sample belongs to an attribute group; determine, if the attribute group flag indicates that the first sub-sample belongs to the attribute group, an identifier of the first attribute group to which the first sub-sample belongs; and determine the first attribute group based on the identifier of the first attribute group.

In some embodiments, the third information includes an attribute dependency group flag, the fourth information includes a default attribute flag, the attribute dependency group flag is configured for indicating whether the decoding dependency relationship exists between attribute components corresponding to the first attribute group, and the default attribute flag is configured for indicating whether the attribute components corresponding to the first attribute group are default presented attribute components.

In some embodiments, the data determination unit 11 is specifically configured to acquire point cloud component description information of the point cloud file, the point cloud component description information being configured for describing at least one of types of point cloud components, a type list of attribute components, a number list of attribute components of different types, an identifier of an attribute group to which the attribute component belongs, and description information of the attribute group that are included in tracks of the point cloud file; and determine the to-be-decoded first attribute data from the point cloud file based on the point cloud component description information.

The apparatus embodiment and the method embodiment may correspond to each other, and reference can be made to the method embodiment for similar description. To avoid repetition, the similar description will not be repeated herein. Specifically, the apparatus 10 shown in FIG. 9 may perform the method embodiment corresponding to the file decapsulation device, and the aforementioned and other operations and/or functions of modules in the apparatus 9 are to implement the method embodiment corresponding to the file decapsulation device, and will not be repeated herein for brevity.

FIG. 10 is a schematic structural diagram of an apparatus for encapsulating a point cloud file according to an embodiment of this application. The apparatus 20 for encapsulating a point cloud file includes:
an acquisition unit 21 configured to acquire a point cloud bitstream, the point
cloud bitstream including N groups of attribute data, and N being a positive integer; and
an encapsulation unit 22 configured to encapsulate, for to-be-encapsulated first
attribute data in the N groups of attribute data, the first attribute data based on a first relationship between the first attribute data and second attribute data, determine dependency indication information of the first attribute data, and acquire the point cloud file;
the dependency indication information being configured for indicating
whether the first relationship exists between the first attribute data and the second attribute data, and the first relationship including at least one of an encoding dependency relationship and a presentation association relationship.

In some embodiments, the encapsulation unit 22 is specifically configured to acquire, if the encoding dependency relationship exists between the first attribute data and the second attribute data, the second attribute data, and encapsulate the first attribute data based on the second attribute data; and separately encapsulate, if the encoding dependency relationship does not exist between the first attribute data and the second attribute data, the first attribute data.

In some embodiments, the encapsulation unit 22 is specifically configured to encapsulate the first attribute data and the second attribute data in a first track if the point cloud bitstream adopts component-based multi-track encapsulation; and identify, if an attribute component in the point cloud bitstream is encapsulated in a second track, the first attribute data and the second attribute data in the second track as belonging to a first attribute group, the second track being a track encapsulating the point cloud bitstream in a single-track encapsulation mode or a slice track encapsulating all components of a specific slice of the point cloud bitstream.

In some embodiments, if the point cloud bitstream adopts the component-based multi-track encapsulation, the dependency indication information includes at least one of first information and second information. The encapsulation unit 22 is specifically configured to determine at least one of the first information and the second information that correspond to the first track, the first information being configured for indicating a number of attribute components included in the first track, the second information being configured for indicating whether the first track includes an attribute group, and the first track being configured to encapsulate the first attribute data and the second attribute data.

In some embodiments, if the encoding dependency relationship exists between the first attribute data and the second attribute data, the first information is determined to indicate that the number of the attribute components included in the first track is greater than 1.

If the encoding dependency relationship does not exist between the first attribute data and the second attribute data, the first information is determined to indicate that the number of the attribute components included in the first track is equal to 1.

If the presentation association relationship exists between the first attribute data and the second attribute data, it is determined that the second information indicates that the first track includes the attribute group.

If the presentation association relationship does not exist between the first attribute data and the second attribute data, it is determined that the second information indicates that the first track does not include the attribute group.

In some embodiments, the first information includes first attribute component number indication information, the first attribute component number indication information being configured for indicating the number of the attribute components included in the first track. Alternatively,
the first information includes attribute component type number indication information and second attribute component number indication information, the attribute component type number indication information being configured for indicating a number of different types of the attribute components included in the first track, and the second attribute component number indication information being configured for indicating a number of attribute components of each type; and
the second information includes an attribute group information flag, the attribute group information flag indicating whether to indicate attribute group information.

In some embodiments, if the presentation association relationship exists between the first attribute data and the second attribute data, and the first attribute data and the second attribute data are divided into a second attribute group, the encapsulation unit 22 is further configured to determine an identifier of the second attribute group, and add the identifier of the second attribute group to the point cloud file.

In some embodiments, if the first attribute data and the second attribute data are identified as belonging to the first attribute group, the encapsulation unit 22 is further configured to determine an attribute group flag corresponding to a first sub-sample where the first attribute data are located, the attribute group flag being configured for indicating whether the first sub-sample belongs to an attribute group; determine, if the attribute group flag indicates that the first sub-sample belongs to the attribute group, an identifier of the first attribute group to which the first sub-sample belongs; and encapsulate the attribute group flag and the identifier of the first attribute group in the second track.

In some embodiments, if the attribute component in the point cloud bitstream is encapsulated in the second track, and the dependency indication information includes at least one of third information and fourth information, the encapsulation unit 22 is specifically configured to determine at least one of the third information and the fourth information that correspond to the first attribute group, the third information being configured for indicating whether the decoding dependency relationship exists between attribute components in the first attribute group, and the fourth information being configured for indicating whether the presentation association relationship exists between the attribute components in the first attribute group.

In some embodiments, the third information includes an attribute dependency group flag, the fourth information includes a default attribute flag, the attribute dependency group flag is configured for indicating whether the decoding dependency relationship exists between attribute components corresponding to the first attribute group, and the default attribute flag is configured for indicating whether the attribute components corresponding to the first attribute group are default presented attribute components.

In some embodiments, the encapsulation unit 22 is specifically configured to determine point cloud component description information of the point cloud file, the point cloud component description information being configured for describing at least one of types of point cloud components, a type list of attribute components, a number list of attribute components of different types, an identifier of an attribute group to which the attribute component belongs, and description information of the attribute group that are included in tracks of the point cloud file.

The apparatus embodiment and the method embodiment may correspond to each other, and reference can be made to the method embodiment for similar description. To avoid repetition, the similar description will not be repeated herein. Specifically, the apparatus 20 shown in FIG. 10 may perform the method embodiment corresponding to the file encapsulation device, and the aforementioned and other operations and/or functions of modules in the apparatus 20 are to implement the method embodiment corresponding to the file encapsulation device, and will not be repeated herein for brevity.

The apparatus of the embodiment of this application is described from the perspective of a functional module with reference to the accompanying drawings. The functional module may be implemented through hardware, an instruction in the form of software, or through a combination of the hardware and a software module. Specifically, steps of the method embodiment in the embodiment of this application may be completed by an integrated logic circuit of hardware and/or an instruction in the form of software in a processor. The steps of the method disclosed in conjunction with the embodiment of this application may be directly embodied to be performed and completed by a hardware decoding processor, or may be performed and completed through a combination of hardware and software modules in the decoding processor. In some embodiments, the software module may be located in a mature storage medium in the art, such as a random access memory, a flash memory, a read-only memory, a programmable read-only memory, an electrically erasable programmable memory, and a register. The storage medium is located in the memory, and the processor reads information in the memory, and completes the steps of the method embodiment in combination with its hardware.

FIG. 11 is a schematic block diagram of an electronic device according to an embodiment of this application. The electronic device may be the file decapsulation device or the file encapsulation device.

With reference to FIG. 11, the electronic device 30 may include:

a memory 31 and a processor 32. The memory 31 is configured to store a computer program 33, and transmit program codes 33 to the processor 32. In other words, the processor 32 may invoke and run the computer program 33 from the memory 31 to implement the method in the embodiment of this application.

For example, the processor 32 may be configured to perform steps in the method according to the instruction in the computer program 33.

In some embodiments of this application, the processor 32 may include, but is not limited to:

a general-purpose processor, a digital signal processor (DSP), an application specific integrated circuit (ASIC), a field-programmable gate array (FPGA), or a different programmable logic device, discrete gate or transistor logic device, or a discrete hardware component.

In some embodiments of this application, the memory 31 includes, but is not limited to:

a volatile memory and/or nonvolatile memory. The nonvolatile memory may be a read-only memory (ROM), a programmable read-only memory (PROM), an erasable programmable read-only memory (EPROM), an electrically erasable programmable read-only memory (EEPROM) or a flash memory. The volatile memory may be a random access memory (RAM), and is used as an external cache. By way of illustration without limitation, numerous forms of RAMs are available, such as a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synch link dynamic random access memory (SLDRAM), and a direct rambus random access memory (DR RAM).

In some embodiments of this application, the computer program 33 may be divided into one or more modules. The one or more modules are stored in the memory 31 and are performed by the processor 32, so as to complete the method for recording pages provided by this application. The one or more modules may be a series of computer program instruction segments that may complete specific functions, and the instruction segments are configured to describe an execution process of the computer program 33 in the electronic device.

As shown in FIG. 11, the electronic device 30 may further include:

a transceiver 34, the transceiver 34 being connected to the processor 32 or the memory 31.

The processor 32 may control the transceiver 34 to communicate with other devices. Specifically, the processor may transmit information or data to other devices or receive information or data from the other devices. The transceiver 34 may include a transmitter and a receiver. The transceiver 34 may further include an antenna, and one or more number of antennas may be provided.

All components in the electronic device 30 are connected through a bus system. The bus system further includes a power bus, a control bus, and a status signal bus besides a data bus.

According to an aspect of this application, a computer storage medium is provided. The computer storage medium has a computer program stored therein, the computer program, when executed by a computer, causing a computer to perform the method according to the method embodiment. In other words, the embodiment of this application further provides a computer program product. The computer program product includes an instruction, the instruction, when executed by a computer, causing a computer to perform the method according to the method embodiment.

According to another aspect of this application, a computer program product or a computer program is provided. The computer program product or the computer program includes a computer instruction, the computer instruction being stored in a computer-readable storage medium. A processor of a computer device reads the computer instruction from the computer-readable storage medium, and the processor, when executing the computer instruction, causes the computer device to perform the method according to the method embodiment.

The implementations described above are merely specific implementations of this application, but the protection scope of this application is not limited to such implementations. Any change or substitution that can be easily conceived by any person of ordinary skill in the art within the technical scope disclosed by this application is to fall within the protection scope of this application. Thus, the protection scope of this application is to be subject to the protection scope of the claims.

What is claimed is:

1. A method for decapsulating a point cloud file, comprising:
determining target first attribute data from a point cloud file, the point cloud file being generated by encapsulating a point cloud bitstream;
determining dependency indication information of the first attribute data, the dependency indication information indicating whether a first relationship exists between the first attribute data and second attribute data in the point cloud file; and
decoding the first attribute data based on the dependency indication information.

2. The method according to claim 1, wherein the decoding the first attribute data based on the dependency indication information comprises:
when the dependency indication information indicates that a decoding dependency relationship exists between the first attribute data and the second attribute data, determining the second attribute data in the point cloud file and decoding the first attribute data based on the second attribute data; and
when the dependency indication information indicates that the decoding dependency relationship does not exist between the first attribute data and the second attribute data, decoding the first attribute data separately from the second attribute file.

3. The method according to claim 2, wherein the determining the second attribute data in the point cloud file comprises:
determining a first track where the first attribute data are located, and determining that other attribute data except the first attribute data from the first track are the second attribute data when the point cloud bitstream adopts component-based multi-track encapsulation; and
determining a first attribute group to which the first attribute data belong, and determining that other attribute data except the first attribute data from the first attribute group are the second attribute data when an attribute component in the point cloud bitstream is encapsulated in a second track, the second track being a track encapsulating the point cloud bitstream in a single-track encapsulation mode or a slice track encapsulating all components of a specific slice of the point cloud bitstream.

4. The method according to claim 3, wherein when the point cloud bitstream adopts the component-based multi-track encapsulation, the dependency indication information comprises at least one of first information and second information, and the determining dependency indication information of the first attribute data comprises:
determining the first track where the first attribute data are located; and
determining at least one of the first information and the second information that correspond to the first track, the first information indicating a number of attribute components comprised in the first track, and the second information indicating whether the first track comprises an attribute group.

5. The method according to claim 4, wherein
when the first information indicates that the number of the attribute components comprised in the first track is greater than 1, the decoding dependency relationship exists between the first attribute data and the second attribute data;
when the first information indicates that the number of the attribute components comprised in the first track is equal to 1, the decoding dependency relationship does not exist between the first attribute data and the second attribute data;
when the second information indicates that the first track comprises the attribute group, a presentation association relationship exists between the first attribute data and the second attribute data; and
when the second information indicates that the first track does not comprise the attribute group, the presentation association relationship does not exist between the first attribute data and the second attribute data.

6. The method according to claim 3, wherein when the attribute component in the point cloud bitstream is encapsulated in the second track, the dependency indication information comprises at least one of third information and fourth information, and the determining dependency indication information of the first attribute data comprises:
determining the first attribute group to which the first attribute data belong, the second track being the track encapsulating the point cloud bitstream in the single-track encapsulation mode or the slice track encapsulating all the components of the specific slice of the point cloud bitstream; and
determining at least one of the third information and the fourth information that correspond to the first attribute group, the third information indicating whether the decoding dependency relationship exists between attribute components in the first attribute group, and the fourth information indicating whether the presentation association relationship exists between the attribute components in the first attribute group.

7. The method according to claim 1, wherein the determining the target first attribute data from the point cloud file comprises:
acquiring point cloud component description information of the point cloud file, the point cloud component description information indicating at least one of types of point cloud components, a type list of attribute components, a number list of attribute components of different types, an identifier of an attribute group to which the attribute component belongs, and description information of the attribute group that are comprised in tracks of the point cloud file; and
determining the target first attribute data from the point cloud file based on the point cloud component description information.

8. The method according to claim 1, wherein the first relationship comprises at least one of a decoding dependency relationship and a presentation association relationship.

9. An electronic device, comprising:
a processor and a memory, the memory being configured to store a computer program, and the processor being configured to invoke and run the computer program stored in the memory and causing the electronic device to perform a method for decapsulating a point cloud file including:
determining target first attribute data from a point cloud file, the point cloud file being generated by encapsulating a point cloud bitstream;
determining dependency indication information of the first attribute data, the dependency indication information indicating whether a first relationship exists between the first attribute data and second attribute data in the point cloud file; and
decoding the first attribute data based on the dependency indication information.

10. The electronic device according to claim 9, wherein the decoding the first attribute data based on the dependency indication information comprises:
when the dependency indication information indicates that a decoding dependency relationship exists between the first attribute data and the second attribute data, determining the second attribute data in the point cloud file and decoding the first attribute data based on the second attribute data; and
when the dependency indication information indicates that the decoding dependency relationship does not exist between the first attribute data and the second attribute data, decoding the first attribute data separately from the second attribute file.

11. The electronic device according to claim 10, wherein the determining the second attribute data in the point cloud file comprises:
determining a first track where the first attribute data are located, and determining that other attribute data except the first attribute data from the first track are the second attribute data when the point cloud bitstream adopts component-based multi-track encapsulation; and
determining a first attribute group to which the first attribute data belong, and determining that other attribute data except the first attribute data from the first attribute group are the second attribute data when an attribute component in the point cloud bitstream is encapsulated in a second track, the second track being a track encapsulating the point cloud bitstream in a single-track encapsulation mode or a slice track encapsulating all components of a specific slice of the point cloud bitstream.

12. The electronic device according to claim 11, wherein when the point cloud bitstream adopts the component-based multi-track encapsulation, the dependency indication information comprises at least one of first information and second information, and the determining dependency indication information of the first attribute data comprises:
determining the first track where the first attribute data are located; and
determining at least one of the first information and the second information that correspond to the first track, the first information indicating a number of attribute components comprised in the first track, and the second information indicating whether the first track comprises an attribute group.

13. The electronic device according to claim 12, wherein
when the first information indicates that the number of the attribute components comprised in the first track is greater than 1, the decoding dependency relationship exists between the first attribute data and the second attribute data;
when the first information indicates that the number of the attribute components comprised in the first track is equal to 1, the decoding dependency relationship does not exist between the first attribute data and the second attribute data;
when the second information indicates that the first track comprises the attribute group, a presentation association relationship exists between the first attribute data and the second attribute data; and
when the second information indicates that the first track does not comprise the attribute group, the presentation association relationship does not exist between the first attribute data and the second attribute data.

14. The electronic device according to claim 11, wherein when the attribute component in the point cloud bitstream is encapsulated in the second track, the dependency indication information comprises at least one of third information and fourth information, and the determining dependency indication information of the first attribute data comprises:
determining the first attribute group to which the first attribute data belong, the second track being the track encapsulating the point cloud bitstream in the single-track encapsulation mode or the slice track encapsulating all the components of the specific slice of the point cloud bitstream; and
determining at least one of the third information and the fourth information that correspond to the first attribute group, the third information indicating whether the decoding dependency relationship exists between attribute components in the first attribute group, and the fourth information indicating whether the presentation association relationship exists between the attribute components in the first attribute group.

15. The electronic device according to claim 9, wherein the determining the target first attribute data from the point cloud file comprises:
acquiring point cloud component description information of the point cloud file, the point cloud component description information indicating at least one of types of point cloud components, a type list of attribute components, a number list of attribute components of different types, an identifier of an attribute group to which the attribute component belongs, and description information of the attribute group that are comprised in tracks of the point cloud file; and
determining the target first attribute data from the point cloud file based on the point cloud component description information.

16. The electronic device according to claim 9, wherein the first relationship comprises at least one of a decoding dependency relationship and a presentation association relationship.

17. A non-transitory computer-readable storage medium having a computer program stored therein, the computer program, when executed by a processor of a computer device, causing the computer device to perform a method for decapsulating a point cloud file including:
determining target first attribute data from a point cloud file, the point cloud file being generated by encapsulating a point cloud bitstream;
determining dependency indication information of the first attribute data, the dependency indication information indicating whether a first relationship exists between the first attribute data and second attribute data in the point cloud file; and
decoding the first attribute data based on the dependency indication information.

18. The non-transitory computer-readable storage medium according to claim 17, wherein the decoding the first attribute data based on the dependency indication information comprises:
when the dependency indication information indicates that a decoding dependency relationship exists between the first attribute data and the second attribute data, determining the second attribute data in the point cloud file and decoding the first attribute data based on the second attribute data; and
when the dependency indication information indicates that the decoding dependency relationship does not exist between the first attribute data and the second attribute data, decoding the first attribute data separately from the second attribute file.

19. The non-transitory computer-readable storage medium according to claim 17, wherein the determining the target first attribute data from the point cloud file comprises:
acquiring point cloud component description information of the point cloud file, the point cloud component description information indicating at least one of types of point cloud components, a type list of attribute components, a number list of attribute components of different types, an identifier of an attribute group to which the attribute component belongs, and description information of the attribute group that are comprised in tracks of the point cloud file; and
determining the target first attribute data from the point cloud file based on the point cloud component description information.

20. The non-transitory computer-readable storage medium according to claim 17, wherein the first relationship comprises at least one of a decoding dependency relationship and a presentation association relationship.
